(19) United States
(12) Patent Application Publication
(10) Pub. No.: US 2026/0064215 A1
(43) Pub. Date: Mar. 5, 2026

(54) LIGHT SOURCE-EQUIPPED SENSOR SUBSTRATE, LIGHT SOURCE SUBSTRATE, AND DISPLAY

(71) Applicant: Wacom Co., Ltd., Saitama (JP)

(72) Inventors: Joo Hoon LEE, Saitama (JP); Yoshihisa SUGIYAMA, Saitama (JP); Yoshihiro KOTANI, Saitama (JP); Hidemasa YAMAGUCHI, Saitama (JP); Hiroshi MIZUHASHI, Saitama (JP); Fumitaka GOTO, Saitama (JP)

(73) Assignee: Wacom Co., Ltd., Saitama (JP)

(21) Appl. No.: 19/382,719

(22) Filed: Nov. 7, 2025

Related U.S. Application Data
(63) Continuation of application No. PCT/JP2024/018178, filed on May 16, 2024.

(30) Foreign Application Priority Data
May 16, 2023 (JP) 2023-081058

(51) Int. Cl. G06F 3/041; G02F 1/1333; G02F 1/13357; G06F 3/046

(52) U.S. Cl. CPC G06F 3/0412; G02F 1/13338; G02F 1/133602; G06F 3/046; G06F 3/04164

(57) ABSTRACT

Provided is a light source-equipped sensor substrate including a plurality of mounting layers mounted with a light emitting element array as a plurality of light emitting elements, a driving wiring unit of the light emitting element array, and a coil wiring unit including a detecting coil group, and one or more insulating layers configured to insulate adjacent layers of the plurality of mounting layers from each other, the plurality of mounting layers including a first mounting layer provided with at least the light emitting element array and a part of the driving wiring unit, and a second mounting layer provided with at least a part or a whole of the coil wiring unit, and the first mounting layer being further provided with a part of the coil wiring unit, and/or the second mounting layer being further provided with another part of the driving wiring unit.

### BACKGROUND

### Technical Field

The present disclosure relates to a light source-equipped sensor substrate, a light source substrate, and a display device.

### Description of the Related Art

A direct-type backlight having a light emitting element array disposed on the back side of a display panel to form a surface light source is known in a technical field of display devices (see, for example, JP2002/258770, JP2016/066598, and JP2019/016631). In the following, an electronic circuit substrate mounted with a light emitting element array may be referred to as a light source substrate.

A position-detecting sensor may be incorporated on the front side or the back side of a display panel in order to provide the display device with a handwriting input function. For example, a system for this kind of sensor is an electromagnetic induction (EMR) system that detects an alternating magnetic field sent out from a position indicator through a plurality of detecting coils arranged two-dimensionally. An electronic circuit substrate mounted with the a position detecting sensor may be referred to as a sensor substrate.

There is a configuration where the light source substrate and the sensor substrate are superposed and assembled when the above-described substrates are mounted. However, in a case where the light emitting element array is disposed in one outermost surface layer and the detecting coils are disposed in another outermost surface layer, terminals are provided at different positions in the thickness direction of the substrate assembly. This may cause, for example, a decrease in efficiency of terminal connection work and limitation of housing spaces.

### BRIEF SUMMARY

The present disclosure has been made in view of such problems mentioned above. It is an object of the present disclosure to provide a light source-equipped sensor substrate, a light source substrate, and a display device that can improve a degree of freedom of designing a substrate for a position detecting function and a light emitting function.

In order to solve the above problems, a light source-equipped sensor substrate according to a first aspect of the present disclosure includes a plurality of mounting layers mounted with a plurality of light emitting elements arranged two-dimensionally along a first direction and a second direction intersecting the first direction as a light emitting element array. In addition, there is a driving wiring unit of the light emitting element array, a coil wiring unit including a detecting coil group for detecting a signal from an electromagnetic induction type electronic pen, and one or more insulating layers configured to insulate adjacent layers of the plurality of mounting layers from each other. The plurality of mounting layers includes a first mounting layer provided with at least the light emitting element array and a part of the driving wiring unit and includes a second mounting layer provided with at least a part or a whole of the coil wiring unit. The first mounting layer is further provided with a part of the coil wiring unit, and/or the second mounting layer is further provided with another part of the driving wiring unit.

In addition, the first mounting layer may be provided on an outermost layer side, and the second mounting layer may be provided on a second outermost layer side. The first mounting layer may be provided with at least a light source side terminal as a terminal of the driving wiring unit and a sensor side terminal as a terminal of the coil wiring unit.

In addition, the light source side terminal and the sensor side terminal may be arranged side by side in a peripheral edge portion of the first mounting layer.

In addition, the first mounting layer may be provided on the first outermost layer side, and the second mounting layer may be provided on the second outermost layer side. The second mounting layer may be provided with at least a light source side terminal as a terminal of the driving wiring unit and a sensor side terminal as a terminal of the coil wiring unit.

In addition, the light source side terminal and the sensor side terminal may be arranged side by side in a peripheral edge portion of the second mounting layer.

In addition, the first mounting layer and the second mounting layer may be connected to each other in a lamination direction via a through hole, and at least one light emitting element may be provided the through hole in the first mounting layer or on a periphery of the through hole.

In addition, the plurality of mounting layers may further include a third mounting layer adjacent to the first mounting layer with the insulating layer interposed between the third mounting layer and the first mounting layer The third mounting layer may be provided with a heat radiating solid member formed of a conductor, and at least one slit may be formed in the heat radiating solid member.

In addition, the driving wiring unit may include a plurality of pieces of linear wiring configured to extend in parallel with each other in one direction as viewed in plan from a lamination direction. With a branch point from cathode wiring of the light emitting elements as a start point, the linear wiring may include connection wiring configured to extend to a connection destination. and dummy wiring configured to extend in an opposite direction of the connection destination, also with the branch point as a start point.

In addition, the closer to the connection destination the branch point is located, the longer the dummy wiring may be, and the farther from the connection destination the branch point is located, the shorter the dummy wiring may be.

In addition, the first mounting layer may be provided on the first outermost layer side, and the second mounting layer may be provided on the second outermost layer side. A mark indicating a position of a detection area formed by the detecting coil group may be provided on the second mounting layer.

In addition, the mark or a base of the mark may have a chromatic color.

In addition, the detecting coil group may include a plurality of detecting coils arranged so as to extend in one direction, the direction angled with respect to both the first direction and the second direction when viewed in plan from a lamination direction.

In addition, the detecting coil group may include a plurality of detecting coils arranged so as to extend in the first direction or the second direction as viewed in plan from a lamination direction, and the driving wiring unit may include zigzag-shaped wiring configured to extend in a zigzag shape in one direction.

In addition, the one direction may be a direction angled with respect to both the first direction and the second direction, and the zigzag-shaped wiring may be formed by a combination of a first line segment configured to extend in the first direction and a second line segment configured to extend in the second direction.

In addition, the one direction may be the first direction or the second direction. The zigzag-shaped wiring may be formed by a combination of a first line segment configured to extend in a first angled direction, angled with respect to both the first direction and the second direction, and a second line segment configured to extend in a second angled direction intersecting the first angled direction.

In addition, the detecting coil group may include a plurality of detecting coils disposed so as to extend in the first direction or the second direction as viewed in plan from a lamination direction, and the driving wiring unit may include meander-shaped wiring configured to extend while meandering along the first direction and/or the second direction.

In addition, the driving wiring unit may include a plurality of pieces of linear wiring configured to extend in parallel with each other in one direction as viewed in plan from a lamination direction. One or more pieces of linear wiring among the plurality of pieces of linear wiring may be configured such that a direction of current flowing through the one or more pieces of linear wiring is opposite from a direction of current flowing through remaining pieces of linear wiring.

A light source-equipped sensor substrate according to a second aspect of the present disclosure includes a plurality of mounting layers mounted with a plurality of light emitting elements arranged two-dimensionally along a first direction and a second direction intersecting the first direction as a light emitting element array, and a driving wiring unit of the light emitting element array. It also includes a coil wiring unit including a detecting coil group for detecting a signal from an electromagnetic induction type electronic pen, and one or more insulating layers configured to insulate adjacent layers of the plurality of mounting layers from each other. The plurality of mounting layers includes a first mounting layer provided with the light emitting element array and a part of the driving wiring unit. A second mounting layer is provided with another part of the driving wiring unit and a part of the coil wiring unit, and a third mounting layer is provided with another part of the coil wiring unit.

A light source-equipped sensor substrate according to a third aspect of the present disclosure includes a first printed board mounted with a plurality of light emitting elements arranged two-dimensionally as a with a light emitting element array, and a second printed board mounted with a coil group for detecting an electromagnetic induction type electronic pen. In the second printed board, a plurality of window portions are formed at positions corresponding to the light emitting elements, and the first printed board and the second printed board are laminated to each other in a state in which the light emitting elements are exposed via the window portions.

A display device according to a fourth aspect of the present disclosure includes the light source-equipped sensor substrate in the foregoing first, second, and third aspects, and a non-emissive display panel provided on an upper side of the light source-equipped sensor substrate.

In addition, the foregoing display device may further include a first controller configured to perform light emission control on the light emitting element array, and a second controller configured to perform driving control on a control target object different from the light emitting element array and the display panel. The first controller and the second controller perform timing control such that a light emission period of the light emitting element array and a driving period of the control target object do not overlap each other.

In addition, the foregoing display device may further include a display controller configured to perform display control on the display panel by using a video synchronizing signal, in which the first controller and the second controller perform the timing control on a basis of the video synchronizing signal from the display controller.

In addition, the control target object may be a sending coil for generating an alternating magnetic field, the detecting coil group, or the electromagnetic induction type electronic pen.

In addition, the foregoing display device may further include a capacitive-type touch sensor, in which the control target object is the touch sensor or a capacitive-type electronic pen.

A light source substrate according to a fifth aspect of the present disclosure includes a plurality of mounting layers mounted with a light emitting element array including a plurality of light emitting elements and a driving wiring unit of the light emitting element array, and one or more insulating layers configured to insulate adjacent layers of the plurality of mounting layers from each other. The plurality of mounting layers includes a coil mounting layer provided with one or more sending coils for generating an alternating magnetic field used to detect a signal from an electromagnetic induction type electronic pen.

In addition, the sending coils may be provided so as to encompass a region formed by the light emitting element array as viewed in plan from a lamination direction.

A display device according to a sixth aspect of the present disclosure includes the light source substrate in the foregoing fifth aspect, a non-emissive display panel provided on an upper side of the light source substrate, and a sensor substrate provided on an upper side of the display panel mounted with a detecting coil group for detecting a signal from an electromagnetic induction-type electronic pen.

In addition, the foregoing display device may further include a first controller configured to perform light emission control on the light emitting element array and a second controller configured to perform driving control on a control target object different from the light emitting element array and the display panel. The first controller and the second controller perform timing control such that a light emission period of the light emitting element array and a driving period of the control target object do not overlap each other.

According to the present disclosure, it is possible to improve a degree of freedom of designing a substrate for a position detecting function and a light emitting function.

### BRIEF DESCRIPTION OF THE SEVERAL VIEWS OF THE DRAWINGS

FIG. 1 is a diagram illustrating an exploded perspective view of a display device incorporating a light source-equipped sensor substrate according to a first embodiment;

FIG. 2 is a schematic sectional view of the light source-equipped sensor substrate illustrated in FIG. 1;

FIG. 3 is a schematic sectional view in another example of the light source-equipped sensor substrate illustrated in FIG. 1;

FIG. 4 is a diagram illustrating an example of a circuit configuration possessed by a light source side laminated portion;

FIG. 5 is a diagram illustrating an example of a wiring structure possessed by the light source side laminated portion;

FIG. 6 is a diagram illustrating an example of a circuit configuration possessed by a sensor side laminated portion;

FIG. 7 is a perspective view of the light source-equipped sensor substrate in FIG. 1 as viewed from the back;

FIG. 8 is a diagram schematically illustrating actions and effects obtained by the slit structure in FIG. 5;

FIG. 9 is a diagram illustrating an exploded perspective view of a display device incorporating a light source-equipped sensor substrate according to a second embodiment;

FIG. 10 is a diagram illustrating an example of a circuit configuration possessed by a sensor side laminated portion;

FIG. 11 is a diagram schematically illustrating actions and effects obtained by the circuit configuration in FIG. 10;

FIG. 12 is a diagram illustrating an exploded perspective view of a display device incorporating a light source-equipped sensor substrate according to a third embodiment;

FIG. 13 is a diagram illustrating an example of a circuit configuration possessed by a light source side laminated portion;

FIG. 14 is a diagram schematically illustrating actions and effects obtained by a circuit configuration in FIG. 13;

FIG. 15 is a diagram illustrating a circuit structure in a first modification of the third embodiment;

FIG. 16 is a diagram illustrating a circuit structure in a second modification of the third embodiment;

FIG. 17 is a diagram illustrating a circuit structure in a third modification of the third embodiment;

FIG. 18 is a diagram illustrating a circuit structure in a fourth modification of the third embodiment;

FIG. 19 is a diagram illustrating a circuit structure in a fifth modification of the third embodiment;

FIG. 20 is a diagram illustrating a circuit structure in a sixth modification of the third embodiment;

FIG. 21 is a diagram illustrating an exploded perspective view of a display device incorporating a light source substrate according to a fourth embodiment;

FIG. 22 is a schematic plan perspective view of the light source substrate illustrated in FIG. 19;

FIG. 23 is a diagram schematically illustrating actions and effects of the device configuration of FIG. 20;

FIG. 24 is a schematic plan perspective view of a light source substrate in a modification of the fourth embodiment;

FIG. 25 is a diagram illustrating an exploded perspective view of a display device incorporating a light source-equipped sensor substrate according to a fifth embodiment;

FIG. 26 is a schematic sectional view of the light source-equipped sensor substrate illustrated in FIG. 25;

FIG. 27 is a schematic sectional view illustrating another configuration of the light source-equipped sensor substrate in FIG. 25;

FIG. 28 is a diagram schematically illustrating respective configurations of a light source side mounting portion and a sensor side mounting portion;

FIG. 29 is a diagram schematically illustrating a laminated structure possessed by a light source-equipped sensor substrate of a first type;

FIG. 30 is a diagram schematically illustrating a laminated structure possessed by a light source-equipped sensor substrate of a second type;

FIG. 31 is a diagram schematically illustrating a laminated structure possessed by a light source-equipped sensor substrate of a third type;

FIG. 32 is a diagram schematically illustrating a laminated structure possessed by a light source-equipped sensor substrate of a fourth type;

FIG. 33 is a diagram illustrating a mounting structure of the light source-equipped sensor substrate in an example of the first type;

FIG. 34 is a diagram illustrating a mounting structure of the light source-equipped sensor substrate in an example of the first type;

FIG. 35 is a diagram illustrating a mounting structure of the light source-equipped sensor substrate in an example of the first type;

FIG. 36 is a diagram illustrating a mounting structure of the light source-equipped sensor substrate in a second example of the first type;

FIG. 37 is a diagram illustrating a mounting structure of the light source-equipped sensor substrate in a third example of the first type;

FIG. 38 is a diagram illustrating a mounting structure of the light source-equipped sensor substrate in a fourth example of the first type;

FIG. 39 is a diagram illustrating a mounting structure of the light source-equipped sensor substrate in an example of the third type;

FIG. 40 is a diagram illustrating a mounting structure of the light source-equipped sensor substrate in a second example of the third type;

FIG. 41 is a diagram illustrating a mounting structure of the light source-equipped sensor substrate in a third example of the third type;

FIG. 42 is a schematic block diagram of a display device according to a sixth embodiment;

FIG. 43 is a block diagram illustrating a configuration of a display device in a first example;

FIG. 44 is a timing chart of timing control performed by the display device illustrated in FIG. 43;

FIG. 45 is a block diagram illustrating a configuration of a display device in a second example; and

FIG. 46 is a timing chart of timing control performed by the display device illustrated in FIG. 45.

### DETAILED DESCRIPTION

Embodiments (hereinafter each referred to as a first embodiment, a second embodiment, a third embodiment, a fourth embodiment, a fifth embodiment, and a sixth embodiment) of the present disclosure will hereinafter be described with reference to the accompanying drawings. In order to facilitate understanding of the description, identical constituent elements in the drawings are identified by the same reference symbols where possible, and repeated description thereof will be omitted.

The present disclosure is not limited to the embodiments and modifications below and can be modified freely without departing from the spirit of the present disclosure. Alternatively, configurations may be optionally combined with each other within a scope in which no technical contradiction arises.

### First Embodiment

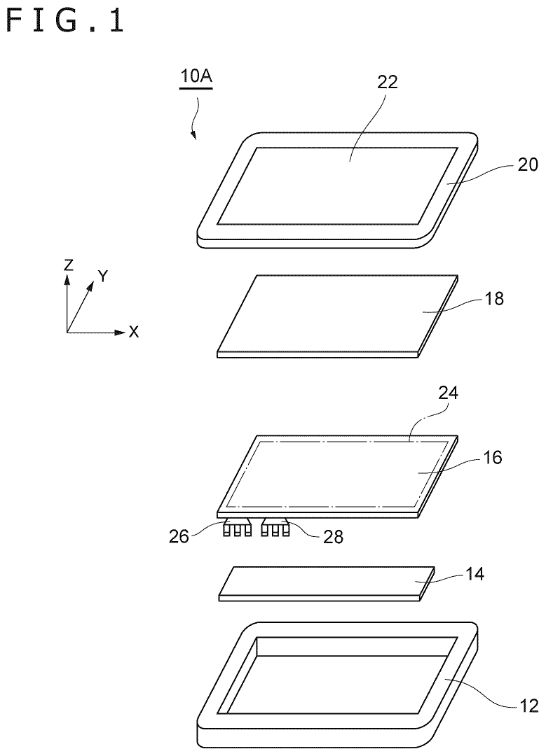

A light source-equipped sensor substrate 16 in a first embodiment of the present disclosure will first be described with reference to FIGS. 1 to 8.

### General Configuration

FIG. 1 is an exploded perspective view of a display device 10A incorporating the light source-equipped sensor substrate 16. The display device 10A may be various kinds of apparatuses mounted with an electronic circuit board. The display device 10A is, for example, a tablet computer used in conjunction with an electronic pen.

In the following, a three-dimensional coordinate system will be defined with the position and posture of the assembled display device 10A as a reference. Specifically, a long side direction, a short side direction, and a height direction of the display device 10A will be respectively referred to as an X-direction, a Y-direction, and a Z-direction. The display device 10A is formed by laminating a back cover 12, a control board 14, the light source-equipped sensor substrate 16, a display panel 18, and a front cover 20 from a back side in order.

The back cover 12 and the front cover 20 are parts of a casing that houses electronic parts within the display device 10A. A protective panel 22 having high transparency is provided to the front cover 20 so as to cover an entire plane of an opening formed in a principal surface of the front cover 20.

The control board 14 is a single board or an aggregate of boards constituting an electric circuit for actuating the display device 10A. Arranged on the control board 14 are various electronic parts such as, for example, a host processor, a memory, a driving integrated circuit (IC) for the light source-equipped sensor substrate 16, a driving IC for the display panel 18, a connector, a wireless communication module, and a power supply circuit.

The light source-equipped sensor substrate 16 is a multilayer substrate that exerts at least a light emitting function and a pen detecting function. The light emitting function is a function of emitting illumination light (what is called backlight) from a back surface to a front surface of the display panel 18. The pen detecting function is to detect a position indicated within a detection area 24 through an electromagnetic induction (EMR) type electronic pen.

Two flexible cables 26 and 28 are electrically connected to the light source-equipped sensor substrate 16 via a connector not illustrated or by compression bonding. The light source-equipped sensor substrate 16 is connected to a connector (not illustrated) on the control board 14 via the flexible cables 26 and 28. The flexible cables 26 and 28 after being connected are arranged on a peripheral edge portion of the light source-equipped sensor substrate 16 and side by side in the X-direction.

The display panel 18 includes a non-emissive display device such as a liquid crystal panel. The display panel 18 drives a plurality of pixels by applying driving voltage to signal lines in a matrix form which signal lines are arranged in a row direction and a column direction. The display panel 18 thereby displays an image or a video within a display region.

### Configuration of Light Source-Equipped Sensor Substrate 16

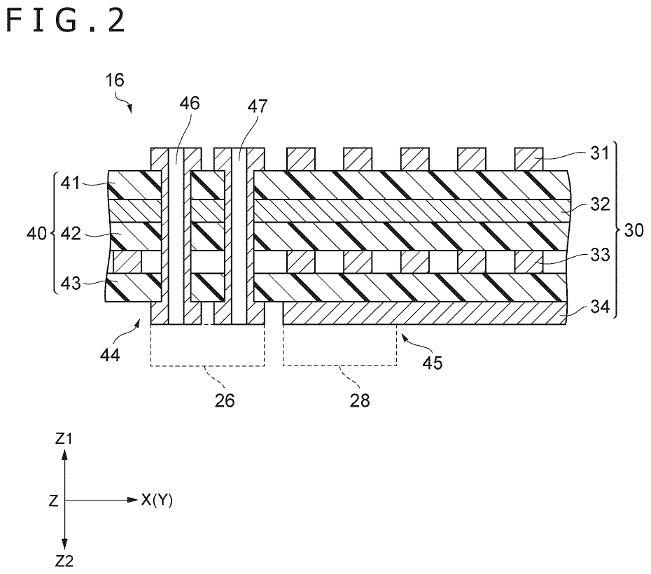

FIG. 2 is a schematic sectional view of the light source-equipped sensor substrate 16 illustrated in FIG. 1. In the following, in a lamination direction of the light source-equipped sensor substrate 16 (that is, the Z-direction), a side close to the display panel 18 will be referred to as a Z1 side, and a side far from the display panel 18 will be referred to as a Z2 side. This light source-equipped sensor substrate 16 includes a plurality of mounting layers 30 and one or more insulating layers 40.

The plurality of mounting layers 30 are mounted with various electronic parts or wiring for exerting the light emitting function and the pen detecting function described above. The wiring is formed of a material having high conductivity (for example, metal such as copper, silver, or gold).

In the example of FIG. 2, the plurality of mounting layers 30 are constituted by four mounting layers 31, 32, 33, and 34.

The one or more insulating layers 40 are provided to insulate adjacent layers of the plurality of mounting layers 30 from each other. The one or more insulating layers 40 are formed of a material having an insulating property and heat resistance (for example, resin such as polyethylene terephthalate). In the example of FIG. 2, the one or more insulating layers 40 are constituted by three insulating layers 41, 42, and 43 from the Z1 side to the Z2 side.

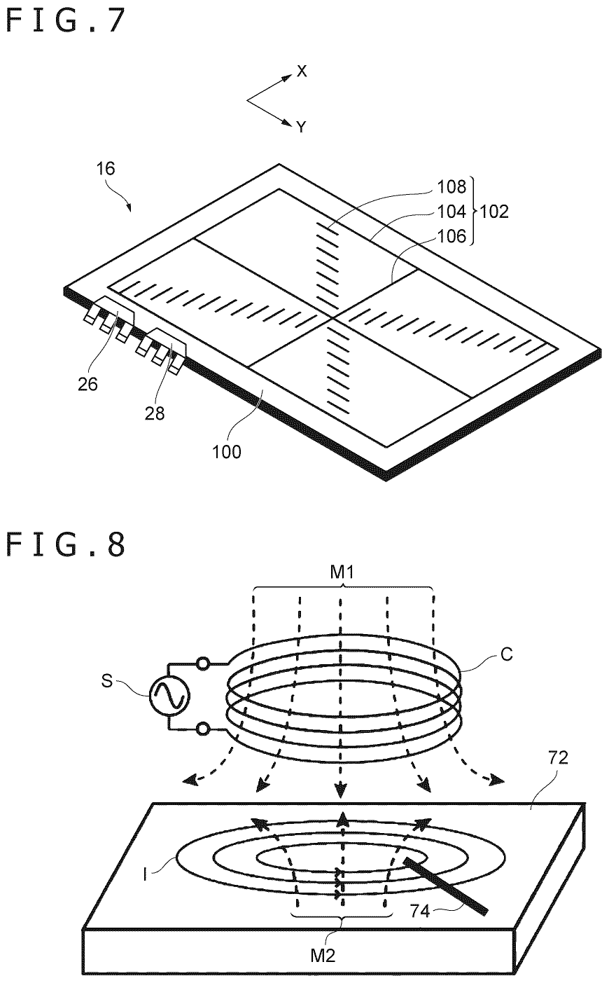

The light source-equipped sensor substrate 16 is formed by laminating the mounting layer 31, the insulating layer 41, the mounting layer 32, the insulating layer 42, the mounting layer 33, the insulating layer 43, and the mounting layer 34 in this order from the Z1 side to the Z2 side. That is, the mounting layer 31 is provided on the first outermost layer side (Z1 side), and the mounting layer 34 is provided on the second outermost layer side (Z2 side). A white solder resist layer (not illustrated) is formed on the mounting layer 31. In addition, as will be described later with reference to FIG. 7, screen printing (or silk printing) is provided on the mounting layer 34.

Incidentally, the mounting layer 34 on the Z2 side is provided with a terminal for connection to the flexible cable 26 (which terminal will hereinafter be referred to as a light source side terminal 44) and a terminal for connection to a flexible cable 28 (which terminal will hereinafter be referred to as a sensor side terminal 45). Wiring within the mounting layers 31 and 32 is routed to the light source side terminal 44 via through holes 46 and 47.

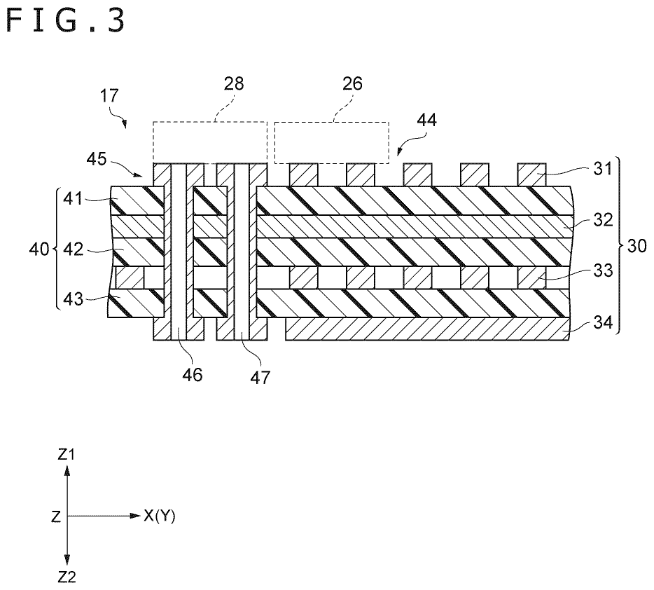

FIG. 3 is a schematic sectional view illustrating another example of a light source-equipped sensor substrate 17 illustrated in FIG. 1. The light source-equipped sensor substrate 17 has the same laminated structure as in the case of FIG. 2. The mounting layer 31 on the Z1 side is provided with the light source side terminal 44 for connection to the flexible cable 26 and the sensor side terminal 45 for connection to the flexible cable 28. Wiring within the mounting layers 33 and 34 is routed to the sensor side terminal 45 via the through holes 46 and 47.

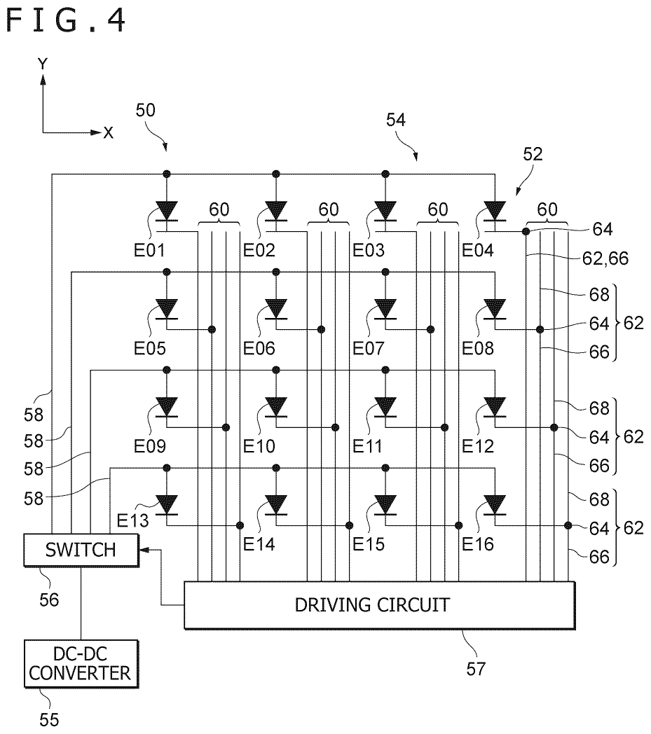

Incidentally, in FIG. 2 or FIG. 3, the mounting layer 31 on the Z1 side is provided with light emitting elements (not illustrated) to be described later in FIG. 4. The light emitting elements are, for example, arranged at the position of the through holes 46 and 47 or on the periphery of the position.

### Configuration of Light Source Side Laminated Portion 50

FIG. 4 is a diagram illustrating an example of a circuit configuration possessed by a light source side laminated portion 50. The light source side laminated portion 50 is comprises the mounting layer 31, the insulating layer 41, and the mounting layer 32 in FIG. 2. Specifically, the light source side laminated portion 50 includes a light emitting element array 52, a driving wiring unit 54, a direct current (DC)-DC converter 55, a switch 56, and a driving circuit 57.

The light emitting element array 52 is an aggregate of light emitting elements arranged in a lattice manner with the X-direction and the Y-direction as two axes. For the convenience of illustration, 16 light emitting elements E01 to E16 are illustrated. However, the number of the light emitting elements is not limited to this. The light emitting elements are light emitting diodes (LED), for example, and may be mini LEDs having a diameter of roughly 100 to 200 μm.

The driving wiring unit 54 includes an aggregate of wiring for driving each of the light emitting elements E01 to E16. The driving wiring unit 54 connects each of the anode sides of the light emitting elements E01 to E16 to the switch 56, and connects the cathode sides of the light emitting elements E01 to E16 to the driving circuit 57.

In the example of FIG. 4, common anode wiring 58 is connected to the anode sides of four light emitting elements having a same position in the Y-direction. Specifically, first anode wiring 58 is connected to the anode sides of the light emitting elements E01, E02, E03, and E04. In addition, second anode wiring 58 is connected to the anode sides of the light emitting elements E05, E06, E07, and E08. In addition, third anode wiring 58 is connected to the anode sides of the light emitting elements E09, E10, E11, and E12. In addition, fourth anode wiring 58 is connected to the anode sides of the light emitting elements E13, E14, E15, and E16.

Individual pieces of cathode wiring are connected to the cathode sides of the respective light emitting elements. In particular, the pieces of cathode wiring of four light emitting elements having a same position in the X-direction extend in the Y-direction at substantially equal intervals, and thereby form parallel wiring 60. Specifically, the pieces of cathode wiring of the light emitting elements E01, E05, E09, and E13 form first parallel wiring 60. In addition, the pieces of cathode wiring of the light emitting elements E02, E06, E10, and E14 form second parallel wiring 60. In addition, the pieces of cathode wiring of the light emitting elements E03, E07, E11, and E15 form third parallel wiring 60. In addition, the pieces of cathode wiring of the light emitting elements E04, E08, E12, and E16 form fourth parallel wiring 60.

Each piece of parallel wiring 60 is formed by a plurality of pieces of linear wiring 62 (four pieces of linear wiring 62 in this case). The linear wiring 62 includes connection wiring 66 extending so as to approach the driving circuit 57 with a branch point 64 of the cathode wiring as a start point and dummy wiring 68 extending so as to separate from the driving circuit 57 with the branch point 64 as a start point. Here, the pieces of linear wiring 62 are provided so as to be equal in length from each other. That is, the closer to the driving circuit 57 the position of the branch point 64, the longer the dummy wiring 68, and the farther from the driving circuit 57 the position of the branch point 64, the shorter the dummy wiring 68. In the example of FIG. 4, the cathode wiring of the light emitting element E04 is provided with no dummy wiring 68.

The DC-DC converter 55 converts a direct-current voltage input from the power supply circuit not illustrated into a direct-current voltage suitable for driving the light emitting elements E01 to E16, and outputs the voltage to the switch 56.

The switch 56 switches an output destination of the direct-current voltage according to a switching signal supplied from the driving circuit 57. An input terminal of the switch 56 is connected to the DC-DC converter 55. An output terminal of the switch 56 is connected to each of the four pieces of anode wiring 58 described above.

The driving circuit 57 is a circuit for performing driving control on the light emitting element array 52. The driving circuit 57 can make the light emitting element array 52 emit light on a time-division basis by, for example, outputting a switching signal for sequentially changing the output destination of the switch 56. For example, the light emitting element array 52 repeats light emission in order of E01 to E04, E05 to E08, E09 to E12, E13 to E16, E01 to E04, . . .

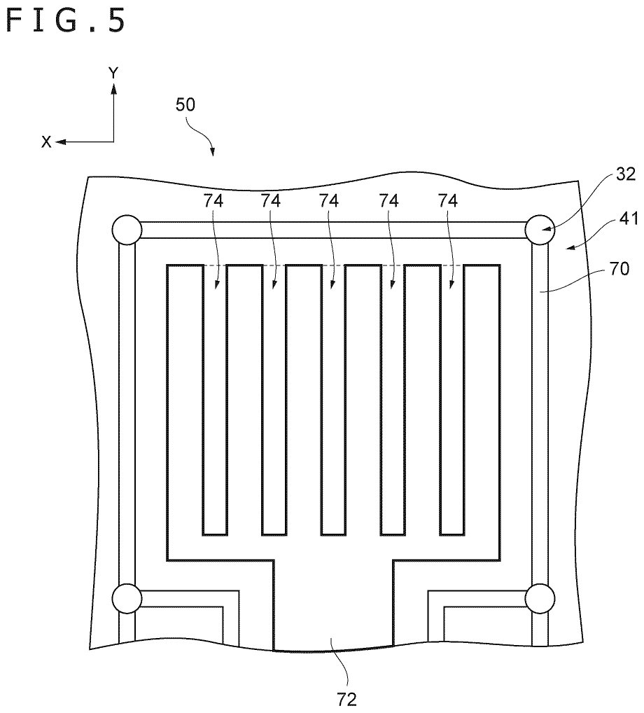

FIG. 5 is a diagram illustrating an example of a wiring structure possessed by the light source side laminated portion 50. More specifically, FIG. 5 corresponds to a partially enlarged perspective view of the light source-equipped sensor substrate 16 as viewed from the back side (that is, the Z2 side in FIG. 2). The mounting layer 33 is provided with a driving wiring unit 70 of the light emitting element array 52 (FIG. 4) and a heat radiating solid member 72.

The heat radiating solid member 72 is provided to transmit heat generated from a heat generation source such as the light emitting element array 52 in an XY plane direction or the Z-direction and release the heat to the outside of the light source-equipped sensor substrate 16. The heat radiating solid member 72 is formed of a material having high heat conductivity (for example, metal such as a copper foil). In a case where the heat radiating solid member 72 is formed by a conductor, the heat radiating solid member 72 is disposed so as to be electrically insulated from the driving wiring unit 70.

The heat radiating solid member 72 has a comb-tooth partial shape. That is, five slits 74 each extending in the Y-direction are formed in the heat radiating solid member 72. Incidentally, the shape, size, and number of the heat radiating solid member 72 or the number, length, and orientation of the slits 74 are not limited to the example illustrated in FIG. 5, and can be changed to various modes.

### Configuration of Sensor Side Laminated Portion 80

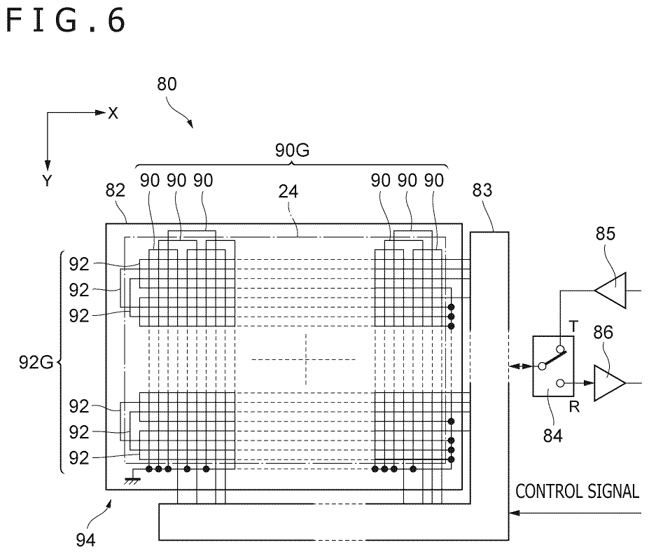

FIG. 6 is a diagram illustrating an example of a circuit configuration possessed by a sensor side laminated portion 80. The sensor side laminated portion 80 comprises the mounting layer 33, the insulating layer 43, and the mounting layer 34 in FIG. 2. The sensor side laminated portion 80 detects a two-dimensional position indicated by the electronic pen through electromagnetic induction occurring between detecting coils 90 and 92 and the electronic pen. Specifically, the sensor side laminated portion 80 is provided with various electronic parts including a sensor unit 82, a selecting circuit 83, a switch 84, a transmission amplifier 85, and a reception amplifier 86.

The sensor unit 82 includes a detecting coil group 90G and a detecting coil group 92G. The detecting coil groups 90G and 92G are arranged so as to form a two-dimensional lattice by intersecting each other. A rectangular detection area 24 (FIG. 1) for indicating a two-dimensional position on XY coordinates is thereby formed. In the following, an aggregate of coil wiring including the detecting coil groups 90G and 92G will be referred to also as a coil wiring unit 94.

The detecting coil group 90G is an aggregate of N (N≥2) detecting coils 90 that are arranged side by side in the X-direction and extend in the Y-direction. Each of the detecting coils 90 has an elongated rectangular shape with a substantially constant width irrespective of a position in the Y-direction. Each of the detecting coils 90 is connected to the selecting circuit 83 on one end side, and is connected to a reference potential (for example, a ground potential) on another end side. The detecting coil group 92G is an aggregate of M (M≥2) detecting coils 92 that are arranged side by side in the Y-direction and extend in the X-direction. As with the detecting coils 90, each of the detecting coils 92 has an elongated rectangular shape with a substantially constant width irrespective of a position in the X-direction. Each of the detecting coils 92 is connected to the selecting circuit 83 on one end side, and is connected to the reference potential (for example, the ground potential) on another end side.

The selecting circuit 83 switches a connection destination in the sensor unit 82 according to a control signal from a controller not illustrated. One detecting coil 90 from among the detecting coil group 90G is thereby selectively connected to the switch 84. Alternatively, one detecting coil 92 from among the detecting coil group 92G is selectively connected to the switch 84.

The switch 84 switches a connection destination to either a T-terminal or an R-terminal according to a control signal from the controller not illustrated. For example, when the connection destination is the T-terminal, the switch 84 outputs a transmission signal supplied from the transmission amplifier 85 to the sensor unit 82. When the connection destination is the R-terminal, in contrast, the switch 84 outputs a reception signal supplied from the sensor unit 82 to the reception amplifier 86.

FIG. 7 is a perspective view of the light source-equipped sensor substrate 16 in FIG. 1 as viewed from the back. Screen printing (or silk printing) is provided to the back surface of the light source-equipped sensor substrate 16, that is, the surface of the mounting layer 34 in FIG. 2. An alignment mark 102 for positioning is formed on a base 100 of a single color through this printing process. Here, whereas the base 100 has a chromatic color such as a green color, the alignment mark 102 has an achromatic color (white color). Conversely, whereas the base 100 may have an achromatic color, the alignment mark 102 may have a chromatic color.

The alignment mark 102 includes a frame mark 104 indicating a boundary line of the detection area 24 (FIG. 1), a cross-shaped mark 106 for indicating a central position and center lines of the detection area 24, and a plurality of line marks 108 indicating a detection pitch.

### Actions and Effects

The light source-equipped sensor substrate 16 in the first embodiment is configured as described above. Actions and effects of the light source-equipped sensor substrate 16 will next be described with reference to FIGS. 1 to 8.

### First Action and Effect

As illustrated in FIG. 2, the mounting layer 34 of the light source-equipped sensor substrate 16 is at least provided with both the light source side terminal 44 as the terminal of the driving wiring unit 54 (FIG. 4) and the sensor side terminal 45 as the terminal of the coil wiring unit 94 (FIG. 6). The adoption of this configuration can improve connection workability of the flexible cables 26 and 28 and a degree of freedom of layout design for the following reasons.

For example, a case in which the light source side terminal 44 is provided in the mounting layer 31 (on the Z1 side) and the sensor side terminal 45 is provided in the mounting layer 34 (on the Z2 side). When the flexible cables 26 and 28 are connected one by one in order, there is a possibility of a need for the work of turning over the light source-equipped sensor substrate 16. In addition, because of different height positions of the flexible cables 26 and 28, there is a possibility of incurring limitation of housing spaces therefor.

Accordingly, when the light source side terminal 44 and the sensor side terminal 45 are provided in the same mounting layer 34 (on the Z2 side), the work of turning over the light source side terminal 44 and the sensor side terminal 45 is unnecessary, and the height positions of the flexible cables 26 and 28 are substantially the same. The limitation of the housing spaces is therefore correspondingly relaxed easily.

The connection workability of the flexible cables 26 and 28 is improved more, or the degree of freedom of layout design is increased more particularly when both the light source side terminal 44 and the sensor side terminal 45 are located in a peripheral portion of the mounting layer 34, the light source side terminal 44 and the sensor side terminal 45 are located at positions close to each other, the light source side terminal 44 and the sensor side terminal 45 are arranged side by side in the X-direction, or the light source side terminal 44 and the sensor side terminal 45 are arranged side by side in the Y-direction.

The foregoing example showed the light source side terminal 44 and the sensor side terminal 45 in a positional relation illustrated in FIG. 2, but the light source side terminal 44 and the sensor side terminal 45 can also be in a positional relation illustrated in FIG. 3.

In addition, in a case where the mounting layers 31 and 34 are connected to each other in the Z-direction via the through holes 46 and 47, at least one light emitting element may be provided at the position of the through holes 46 and 47 in the mounting layer 31 or on the periphery of the position. Consequently, the through holes 46 and 47 function as thermal vias, so that a heat radiation effect of releasing heat generated with the driving of the light emitting element is obtained easily.

### Second Action and Effect

In a case where the plurality of mounting layers 30 include the mounting layer 32 adjacent to the mounting layer 31 with the insulating layer 41 interposed therebetween (FIG. 2), as illustrated in FIG. 5, the mounting layer 32 is provided with the heat radiating solid member 72 formed of a conductor, and at least one slit 74 is formed in the heat radiating solid member 72. The adoption of this configuration can suppress a decrease in the detection level of an EMR signal due to an eddy current for the following reasons.

FIG. 8 is a diagram schematically illustrating an action and an effect obtained by the slit structure of FIG. 5. In a laminated structure such as the light source-equipped sensor substrate 16, the heat radiating solid member 72 and the detecting coils 90 (FIG. 6) are arranged in close positional relation to each other. Then, an eddy current I tends to occur on the surface of the heat radiating solid member 72 when a magnetic flux M1 occurs in the detecting coils 90. As a result, there is a possibility of a decrease in the detection level of the EMR signal due to interference of the magnetic flux M1 with a magnetic flux M2 occurring in an opposite direction.

Accordingly, the provision of the slits 74 in the heat radiating solid member 72 can suppress the occurrence of the eddy current I straddling the slits 74, and thus reduce the magnetic flux M2 (or magnetic flux density). As a result, it is possible to suppress a decrease in the detection level of the EMR signal due to the disposition of the heat radiating solid member 72.

### Third Action and Effect

As illustrated in FIG. 4, the driving wiring unit 54 includes a plurality of pieces of linear wiring 62 (that is, parallel wiring 60) extending in parallel with one direction (for example, the Y-direction). In this case, the linear wiring 62 includes connection wiring 66 extending to the connection destination (for example, the driving circuit 57) with a branch point 64 from the cathode wiring of the light emitting elements E01 to E16 as a start point and dummy wiring 68 extending in an opposite direction of going away from the driving circuit 57 with the branch point 64 as a start point. The adoption of this configuration can suppress nonuniformity of the detection levels of the EMR signal due to eddy current for the following reasons.

In general, the more the wiring density of the driving wiring unit 54 approaches uniformity, the more a degree of effect of the eddy current occurring on the surface of the wiring substantially approaches uniformity irrespective of a position within the detection area 24. For example, when the cathode wiring of light emitting elements at different positions in the Y-direction (for example, E04, E08, E12, and E16) is routed to substantially the same position (for example, a connection position of the driving circuit 57), the length of the connection wiring 66 in the Y-direction tends to differ.

Accordingly, variation in wiring length in the Y-direction is suppressed by providing the dummy wiring 68 having the branch point 64 of the connection wiring 66 as a start point and extending in the opposite direction of going away from the driving circuit 57. That is, the nonuniformity of the detection levels of the EMR signal due to the eddy current can be suppressed by bringing the wiring density of the driving wiring unit 54 in the Y-direction close to uniformity.

In addition, the dummy wiring 68 may be set such that the closer to the driving circuit 57 the branch point 64 is located, the longer the dummy wiring 68 is and the farther from the driving circuit 57 the branch point 64 is located, the shorter the dummy wiring 68 is. It is thereby possible to suppress variation in length in the Y-direction between the pieces of linear wiring 62 constituting the parallel wiring 60.

Incidentally, dummy wiring 68 may be provided on the anode side in conjunction with the dummy wiring 68 on the cathode side or in place of the dummy wiring 68 on the cathode side. In this case, it suffices for linear anode wiring 58 to include connection wiring extending in one direction from a connection source (switch 56 in the example of FIG. 4) and having a branch point of branching to the anode sides of the light emitting elements E01 to E16 as an end point and dummy wiring extending in the one direction with the branch point as a start point. In addition, as in the case illustrated in FIG. 4, the dummy wiring may be such that the closer to the connection source the branch point is located, the longer the dummy wiring is and the farther from the connection source the branch point is located, the shorter the dummy wiring is.

### Fourth Action and Effect

As illustrated in FIG. 7, a white solder resist layer is formed on the mounting layer 31 located on a first outermost layer side, and an alignment mark 102 indicating the position of the detection area 24 formed by the detecting coil groups 90G and 92G is provided on the mounting layer 34 located the second outermost layer side.

Generally speaking, the alignment mark 102 is preferably provided in such a manner as to be easily visible to a worker. For example, it is more preferable from a viewpoint of handling that the alignment mark 102 be provided on the mounting layer 31 corresponding to the front side of the light source-equipped sensor substrate 16. However, because the light emitting element array 52 is mounted in the mounting layer 31, the formation of the mark of a chromatic color may change an emission spectrum of the light emitting element array 52.

Accordingly, when the alignment mark 102 is provided on the mounting layer 34 corresponding to the back side of the light source-equipped sensor substrate 16, the position of the detection area 24 is grasped easily without the emission spectrum of the light emitting element array 52 being affected. In particular, the visibility of the alignment mark 102 is further increased because the alignment mark 102 or the base 100 of the alignment mark 102 has a chromatic color.

### Second Embodiment

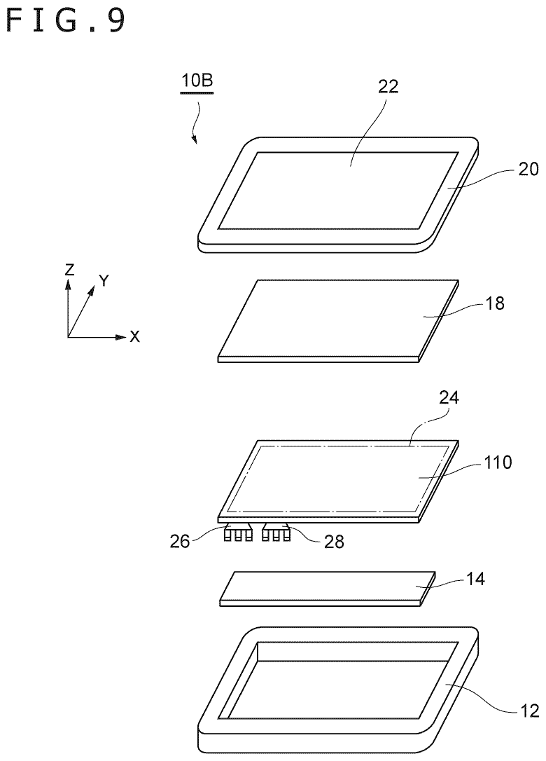

A light source-equipped sensor substrate 110 in a second embodiment of the present disclosure will next be described with reference to FIGS. 9 to 11.

### General Configuration

FIG. 9 is an exploded perspective view of a display device 10B incorporating the light source-equipped sensor substrate 110 according to a second embodiment. This display device 10B is formed by laminating a back cover 12, a control board 14, the light source-equipped sensor substrate 110, a display panel 18, and a front cover 20 from a back side in order. The light source-equipped sensor substrate 110 has a structure different from that in the case of the light source-equipped sensor substrate 16 (FIG. 1) in the first embodiment. While a description will be made by an example where the light source-equipped sensor substrate 110 has a laminated structure similar to that of the first embodiment (FIG. 2 or FIG. 3), the light source-equipped sensor substrate 110 may have a laminated structure different from that in the case of the first embodiment.

### Configuration of Light Source Side Laminated Portion 50

The light source-equipped sensor substrate 110 includes the light source side laminated portion 50 (FIG. 4) in the first embodiment. That is, in the light source side laminated portion 50, a plurality of pieces of linear wiring 62 (that is, parallel wiring 60) are arranged so as to extend in the Y-direction.

### Configuration of Sensor Side Laminated Portion 112

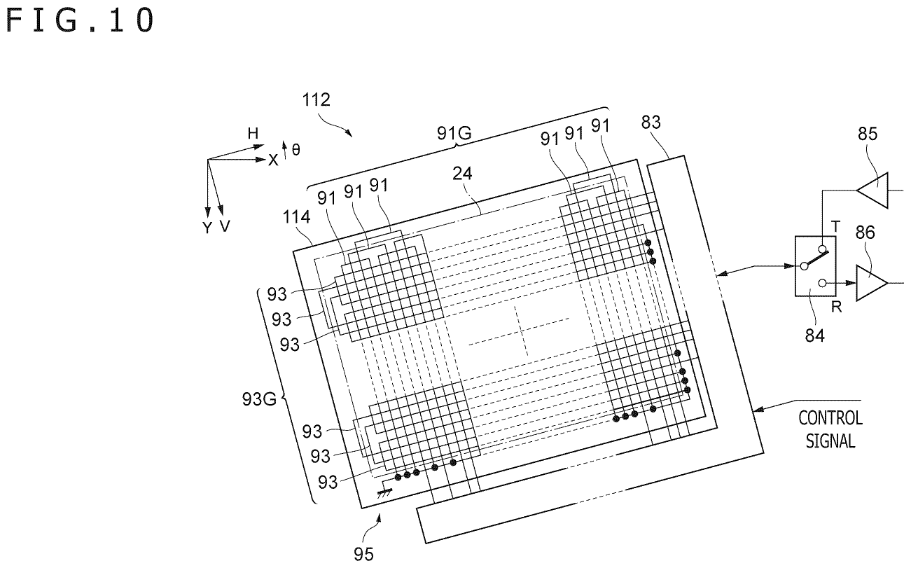

FIG. 10 is a diagram illustrating an example of a circuit configuration possessed by a sensor side laminated portion 112. As in the case of the first embodiment, the sensor side laminated portion 112 is constituted by the mounting layer 33, the insulating layer 43, and the mounting layer 34 in FIG. 2. The sensor side laminated portion 112 is provided with various electronic parts including a sensor unit 114, a selecting circuit 83, a switch 84, a transmission amplifier 85, and a reception amplifier 86.

The sensor unit 114 includes a detecting coil group 91G and a detecting coil group 93G. The detecting coil groups 91G and 93G are arranged so as to form a two-dimensional lattice by intersecting each other. A rectangular detection area 24 (FIG. 1) for indicating a two-dimensional position on XY coordinates is thereby formed. In the following, an aggregate of coil wiring including the detecting coil groups 91G and 93G will be referred to also as a coil wiring unit 95.

The detecting coil group 91G is an aggregate of N (N≥2) detecting coils 91 that are arranged side by side in an H-direction and extend in a V-direction. The detecting coil group 93G is an aggregate of M (M≥2) detecting coils 93 arranged side by side in the V-direction and extend in the H-direction. The H-direction corresponds to a direction angled by an angle θ with respect to the X-direction. The V-direction corresponds to a direction angled by the angle θ with respect to the Y-direction. The angle θ can assume any value in a range 0°<θ≤30°, for example.

Each of the detecting coils 91 has an elongated rectangular shape with a substantially constant width irrespective of a position in the V-direction. Each of the detecting coils 93 has an elongated rectangular shape with a substantially constant width irrespective of a position in the H-direction. Each of the detecting coils 91 and 93 is connected to the selecting circuit 83 on one end side, and is connected to a reference potential (for example, a ground potential) on another end side.

### Actions and Effects

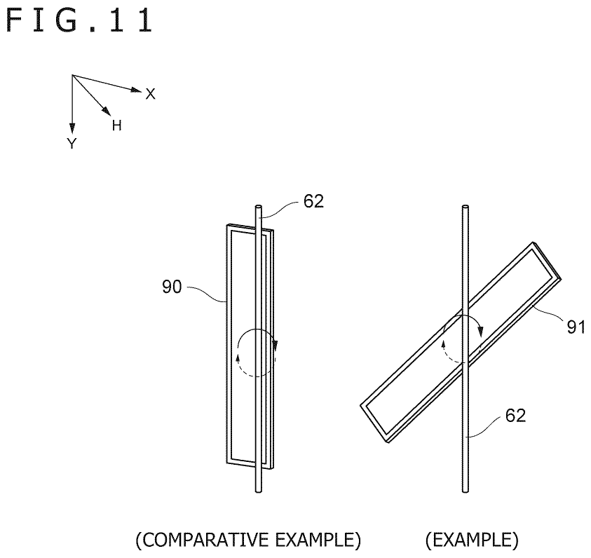

The light source-equipped sensor substrate 110 in the second embodiment is configured as described above. Actions and effects of the light source-equipped sensor substrate 110 will next be described with reference to FIG. 11. FIG. 11 is a diagram schematically illustrating actions and effects obtained by the circuit configuration in FIG. 10.

A comparative example in FIG. 11 assumes a case where linear wiring 62 is provided in parallel with the Y-direction along an arrangement direction of the light emitting element array 52 (FIG. 4). Under a positional relation under which the light source side laminated portion 50 in FIG. 4 and the sensor side laminated portion 80 in FIG. 6 are laminated, electromagnetic interference may occur between a detecting coil 90 and linear wiring 62. In particular, as a wiring section in parallel relation becomes longer, spatial conduction of electromagnetic noise tends to occur through stray capacitance, magnetic coupling, and the like. As a result, the electromagnetic noise may be mixed in the detecting coil 90 and lead to a decrease in detection accuracy and an erroneous operation of the substrate.

In contrast, in an example in FIG. 11, the linear wiring 62 shifts so as to be angled with respect to both the X-direction and the Y-direction. In this case, the detecting coil 91 and the linear wiring 62 are skew lines even when the light source side laminated portion 50 in FIG. 4 and the sensor side laminated portion 112 in FIG. 10 are laminated. Then, the electromagnetic noise is not easily mixed in the detecting coil 91 through an electromagnetic wave canceling effect occurring between the detecting coil 91 and the linear wiring 62. As a result, a decrease in detection accuracy and an erroneous operation of the substrate are suppressed.

As described above, the light source-equipped sensor substrate 110 according to the second embodiment includes the plurality of mounting layers 31 to 34 mounted with the plurality of light emitting elements E01 to E16 as the light emitting element array 52 arranged two-dimensionally along a first direction (X-direction in this case) and a second direction (Y-direction in this case) intersecting the X-direction, the driving wiring unit 54 of the light emitting element array 52, and the coil wiring unit 95 including the detecting coil groups 91G and 93G for detecting a signal from an electromagnetic induction type electronic pen. Moreover, the detecting coil groups 91G and 93G include the plurality of detecting coils 91 and 93 arranged so as to extend in one direction (the H-direction or the V-direction in this case) angled with respect to both the X-direction and the Y-direction as viewed in plan from the lamination direction (Z-direction in this case).

Such a configuration can prevent the linear wiring 62 and the detecting coils 91 and 93 from becoming substantially parallel with each other even when the driving wiring unit 54 of the light emitting element array 52 and the coil wiring unit 95 are laminated while maintaining a parallel relation. It is thereby possible to suppress the occurrence of electromagnetic noise accompanying electromagnetic interference between the pieces of wiring respectively included in the driving wiring unit 54 and the coil wiring unit 95.

### Third Embodiment

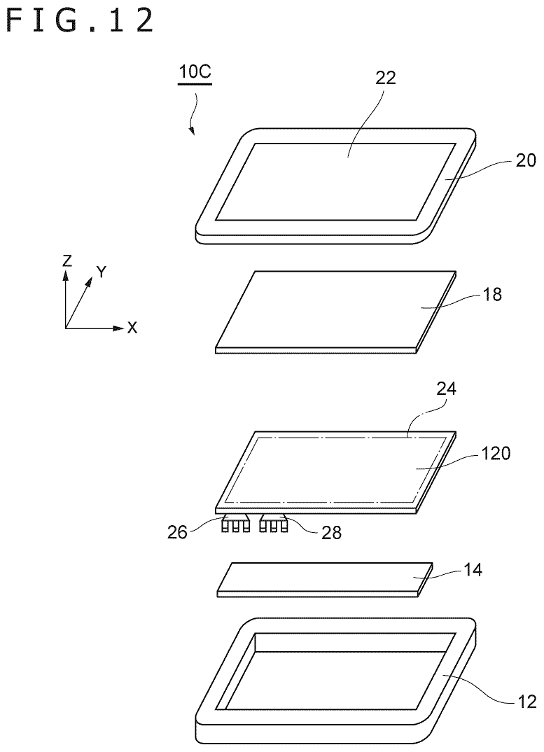

A light source-equipped sensor substrate 120 in a third embodiment of the present disclosure will next be described with reference to FIGS. 12 to 20.

### General Configuration

FIG. 12 is an exploded perspective view of a display device 10C incorporating the light source-equipped sensor substrate 120 according to the third embodiment. This display device 10C is formed by laminating a back cover 12, a control board 14, the light source-equipped sensor substrate 120, a display panel 18, and a front cover 20 from a back side in order. The light source-equipped sensor substrate 120 has a structure different from that in the case of the light source-equipped sensor substrate 16 (FIG. 1) in the first embodiment. While the foregoing example shows the light source-equipped sensor substrate 120 having a laminated structure similar to that in the case of the first embodiment (FIG. 2 or FIG. 3), the light source-equipped sensor substrate 120 may have a laminated structure different from that in the case of the first embodiment.

### Configuration of Light Source Side Laminated Portion 122

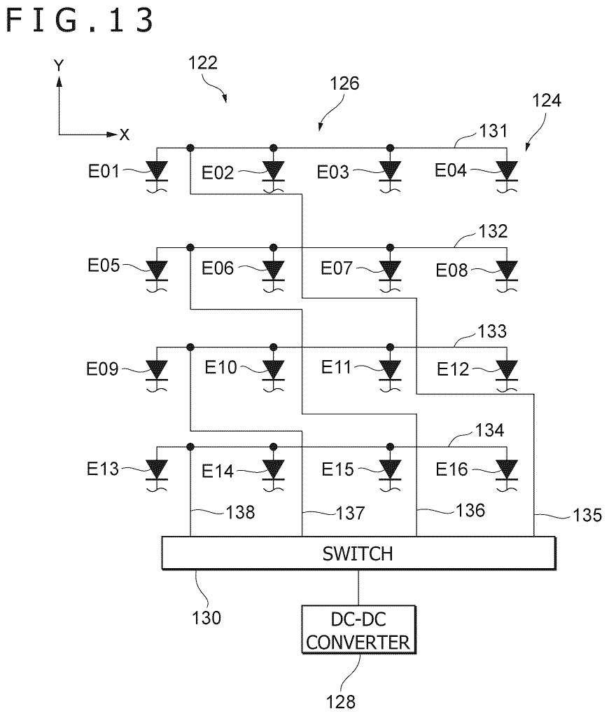

FIG. 13 is a diagram illustrating an example of a circuit configuration possessed by a light source side laminated portion 122. As in the case of the first embodiment (FIG. 4), the light source side laminated portion 122 is constituted by the mounting layer 31, the insulating layer 41, and the mounting layer 32 in FIG. 2. Specifically, the light source side laminated portion 122 includes a light emitting element array 124, a driving wiring unit 126, a DC-DC converter 128, and a switch 130.

The light emitting element array 124 is an aggregate of light emitting elements arranged in a lattice manner with the X-direction and the Y-direction as two axes. As in the case of the first embodiment (FIGS. 4), 16 light emitting elements E01 to E16 are illustrated. However, the number of the light emitting elements is not limited to this.

The driving wiring unit 126 includes an aggregate of wiring for driving each of the light emitting elements E01 to E16. The driving wiring unit 126 connects each of the anode sides of the light emitting elements E01 to E16 to the switch 130, and connects the cathode sides of the light emitting elements E01 to E16 to a driving circuit (not illustrated). Cathode wiring is not depicted for the convenience of illustration.

In the example of FIG. 13, pieces of common anode wiring 131 to 134 are connected to the anode sides of four light emitting elements having a same position in the Y-direction. Specifically, the common anode wiring 131 is connected to the anode sides of the light emitting elements E01, E02, E03, and E04. In addition, the common anode wiring 132 is connected to the anode sides of the light emitting elements E05, E06, E07, and E08. In addition, the common anode wiring 133 is connected to the anode sides of the light emitting elements E09, E10, E11, and E12. In addition, the common anode wiring 134 is connected to the anode sides of the light emitting elements E13, E14, E15, and E16.

The switch 130 and the pieces of anode wiring 131 to 134 are respectively connected to each other by pieces of zigzag-shaped wiring 135 to 138. Each piece of zigzag-shaped wiring 135 to 138 extends in a zigzag shape about one direction having an inclination angle of 45° (which direction will hereinafter be referred to also as an angled direction) with respect to the X-direction and the Y-direction. Each piece of zigzag-shaped wiring 135 to 138 is formed by alternately combining a first line segment extending in the X-direction and a second line segment extending in the Y-direction. Here, the length of the first line segment and the second line segment substantially corresponds to an arrangement interval (corresponding to one pitch) of the light emitting element array 124.

### Configuration of Sensor Side Laminated Portion 80

The light source-equipped sensor substrate 120 includes the sensor side laminated portion 80 (FIG. 6) in the first embodiment. That is, in the sensor side laminated portion 80, the plurality of detecting coils 90 (that is, the detecting coil group 90G) are arranged so as to extend in the Y-direction. Similarly, in the sensor side laminated portion 80, the plurality of detecting coils 92 (that is, the detecting coil group 92G) are arranged so as to extend in the X-direction.

### Actions and Effects

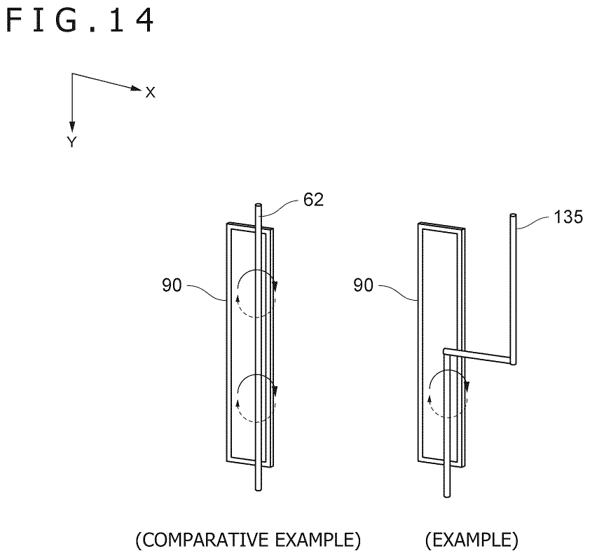

The light source-equipped sensor substrate 120 in the third embodiment is configured as described above. Actions and effects of the third embodiment will next be described with reference to FIG. 14. FIG. 14 is a diagram schematically illustrating actions and effects obtained by the circuit configuration in FIG. 13.

A comparative example in FIG. 14 assumes a case where linear wiring 62 is provided in parallel with the Y-direction along an arrangement direction of the light emitting element array 52 (FIG. 4). Under a positional relation under which the light source side laminated portion 50 in FIG. 4 and the sensor side laminated portion 80 in FIG. 6 are laminated, electromagnetic interference may occur between a detecting coil 90 and linear wiring 62. In particular, as a section of overlap as viewed in plan (what is called an overlap section) becomes longer, spatial conduction of electromagnetic noise tends to occur through stray capacitance, magnetic coupling, and the like. As a result, the electromagnetic noise may be mixed in the detecting coil 90 and lead to a decrease in detection accuracy and an erroneous operation of the substrate.

In contrast, in the example in FIG. 14, zigzag-shaped wiring 135 extends in a zigzag shape so as to straddle a detecting coil 90. The overlap section between the detecting coil 90 and the zigzag-shaped wiring 135 is relatively short even when the light source side laminated portion 122 in FIG. 13 and the sensor side laminated portion 80 in FIG. 6 are laminated. Then, as the overlap section becomes shorter, the electromagnetic noise is correspondingly less likely to be mixed in the detecting coil 90. As a result, a decrease in detection accuracy and an erroneous operation of the substrate are suppressed.

As described above, the light source-equipped sensor substrate 120 in the third embodiment includes the plurality of mounting layers 31 to 34 mounted with the plurality of light emitting elements E01 to E16 arranged two-dimensionally along a first direction (X-direction in this case) and a second direction (Y-direction in this case) intersecting the X-direction as the light emitting element array 124, the driving wiring unit 126 of the light emitting element array 124, and the coil wiring unit 94 including the detecting coil groups 90G and 92G for detecting a signal from an electromagnetic induction type electronic pen. The detecting coil groups 90G and 92G include the plurality of detecting coils 90 and 92 arranged so as to extend in the X-direction or the Y-direction as viewed in plan from the lamination direction (Z-direction in this case). The driving wiring unit 126 includes the pieces of zigzag-shaped wiring 135 to 138 extending in a zigzag shape about one direction angled with respect to both the X-direction and the Y-direction.

With such a configuration, overlap sections between the detecting coils 90 and 92 and the pieces of zigzag-shaped wiring 135 to 138 are relatively short even when the driving wiring unit 126 of the light emitting element array 124 and the coil wiring unit 94 are laminated while maintaining a parallel relation. It is thereby possible to suppress the occurrence of electromagnetic noise accompanying electromagnetic interference between the pieces of wiring respectively included in the driving wiring unit 126 and the coil wiring unit 94.

In FIG. 13, the anode wiring of the light emitting elements E01 to E16 includes zigzag-shaped wiring as an example. However, in addition to this or in place of this, the cathode wiring of the light emitting elements E01 to E16 may be configured to include zigzag-shaped wiring described above. This configuration also provides actions and effects similar to those in the case of FIG. 13 (that is, the effect of suppressing electromagnetic noise).

### Modifications of Light Source-Equipped Sensor Substrate

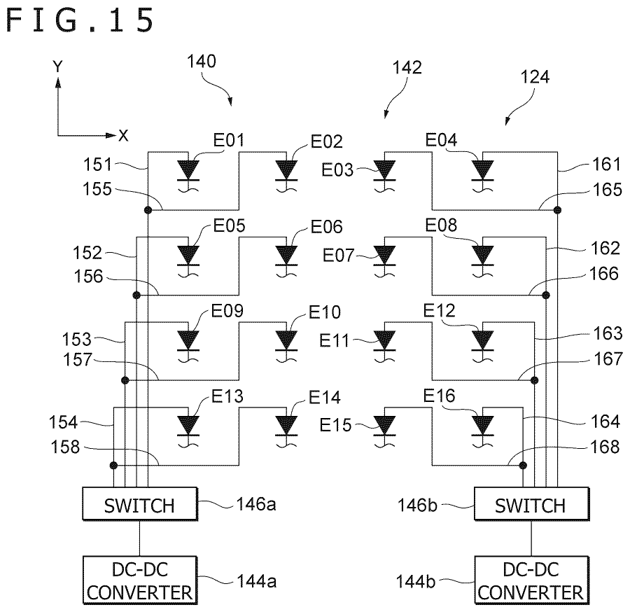

The first to sixth modifications of the light source-equipped sensor substrate 120 in the third embodiment will next be described with reference to FIGS. 15 to 20.

FIG. 15 is a diagram illustrating a circuit structure in a first modification of the third embodiment. As in the case of the third embodiment (FIG. 13), a light source side laminated portion 140 is constituted by the mounting layer 31, the insulating layer 41, and the mounting layer 32 in FIG. 2. Specifically, the light source side laminated portion 140 includes the light emitting element array 124, a driving wiring unit 142, a pair of DC-DC converters 144a and 144b, and a pair of switches 146a and 146b.

The driving wiring unit 142 includes an aggregate of wiring for driving each of the light emitting elements E01 to E16. The driving wiring unit 142 connects each of the anode sides of light emitting elements E01 to E02, E05 to E06, E09 to E10, and E13 to E14 to the one switch 146a, and connects each of the anode sides of light emitting elements E03 to E04, E07 to E08, E11 to E12, and E15 to E16 to the other switch 146b. The driving wiring unit 142 connects the cathode sides of the light emitting elements E01 to E16 to a driving circuit (not illustrated). Cathode wiring is not depicted for the convenience of illustration.

Individual pieces of anode wiring 151, 152, 153, and 154 are respectively connected to the anode sides of four light emitting elements E01, E05, E09, and E13. In addition, pieces of zigzag-shaped wiring 155, 156, 157, and 158 branched from the individual pieces of anode wiring 151 to 154 are respectively connected to the anode sides of four light emitting elements E02, E06, E10, and E14. Each piece of zigzag-shaped wiring 155 to 158 extends in a zigzag shape about one direction having an inclination angle (counterclockwise) of approximately 26.6° with respect to the X-direction. Each piece of zigzag-shaped wiring 155 to 158 is formed by alternately combining a first line segment extending in the X-direction and a second line segment extending in the Y-direction.

Individual pieces of anode wiring 161, 162, 163, and 164 are respectively connected to the anode sides of four light emitting elements E04, E08, E12, and E16. In addition, pieces of zigzag-shaped wiring 165, 166, 167, and 168 branched from the individual pieces of anode wiring 161 to 164 are respectively connected to the anode sides of four light emitting elements E03, E07, E11, and E15. Each piece of zigzag-shaped wiring 165 to 168 extends in a zigzag shape about one direction having an inclination angle (clockwise) of approximately 153.4° with respect to the X-direction. Each piece of zigzag-shaped wiring 165 to 168 is formed by alternately combining a first line segment extending in the X-direction and a second line segment extending in the Y-direction.

Thus, the driving wiring unit 142 includes the pieces of zigzag-shaped wiring 155 to 158 extending in a zigzag shape about a first angled direction (approximately 26.6°) angled with respect to both the X-direction and the Y-direction and the pieces of zigzag-shaped wiring 165 to 168 extending in a zigzag shape about a second angled direction (approximately 153.4°) angled with respect to both the X-direction and the Y-direction. Actions and effects similar to those in the case of the third embodiment (that is, the effect of suppressing electromagnetic noise) are obtained even when the inclination angles formed by center lines of the zigzag shapes are a value other than 45°.

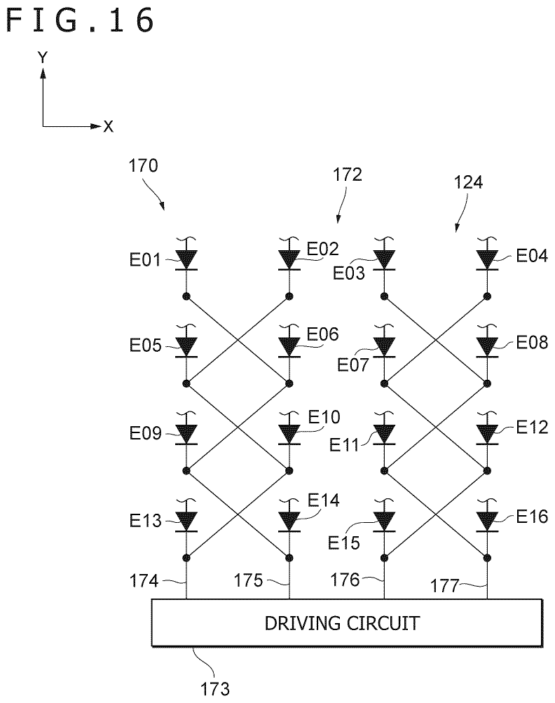

FIG. 16 is a diagram illustrating a circuit structure in a second modification of the third embodiment. As in the case of the third embodiment (FIG. 13), a light source side laminated portion 170 is constituted by the mounting layer 31, the insulating layer 41, and the mounting layer 32 in FIG. 2. Specifically, the light source side laminated portion 170 includes the light emitting element array 124, a driving wiring unit 172, and a driving circuit 173.

The driving wiring unit 172 includes an aggregate of wiring for driving each of the light emitting elements E01 to E16. The driving wiring unit 172 connects each of the cathode sides of the light emitting elements E01 to E16 to the driving circuit 173. The driving wiring unit 172 connects the anode sides of the light emitting elements E01 to E16 to a switch or a DC-DC converter (not illustrated). Anode wiring is not depicted for the convenience of illustration.

Common zigzag-shaped wiring 174 is connected to each of the cathode sides of four light emitting elements E02, E05, E10, and E13. In addition, common zigzag-shaped wiring 175 is connected to each of the cathode sides of four light emitting elements E01, E04, E09, and E14. In addition, common zigzag-shaped wiring 176 is connected to each of the cathode sides of four light emitting elements E04, E07, E12, and E15. In addition, common zigzag-shaped wiring 177 is connected to each of the anode sides of four light emitting elements E03, E08, E11, and E16.

Each piece of zigzag-shaped wiring 174 to 177 extends in a zigzag shape about the Y-direction. Each piece of zigzag-shaped wiring 174 to 177 is formed by alternately combining a first line segment extending in a direction having an inclination angle of 45° with respect to the X-direction (hereinafter, a first angled direction) and a second line segment extending in a direction having an inclination angle of 135° with respect to the X-direction (hereinafter, a second angled direction).

Thus, the driving wiring unit 172 may include the pieces of zigzag-shaped wiring 174 to 177 extending in a zigzag shape about the X-direction or the Y-direction. For example, the pieces of zigzag-shaped wiring 174 to 177 are formed by a combination of the first line segment extending in the first angled direction angled with respect to both the X-direction and the Y-direction and the second line segment extending in the second angled direction intersecting the first angled direction. Thus, actions and effects similar to those in the case of the third embodiment (that is, the effect of suppressing electromagnetic noise) are obtained even when center lines of the zigzag shapes are the X-direction or the Y-direction.

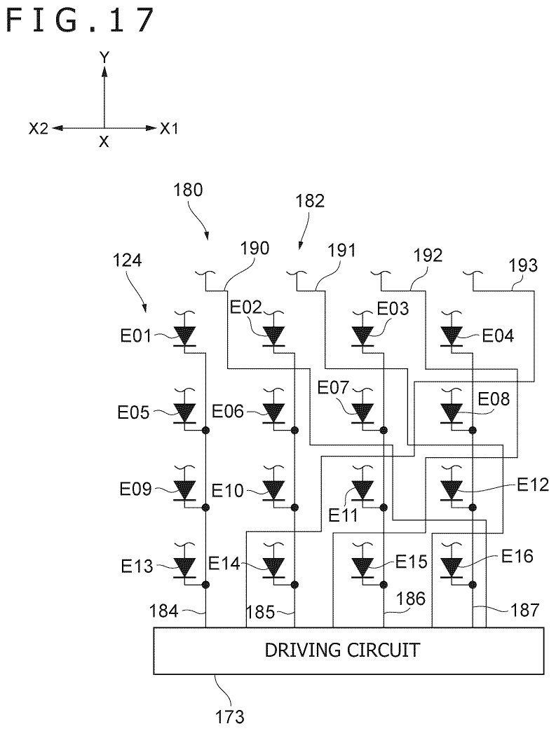

FIG. 17 is a diagram illustrating a circuit structure in a third modification of the third embodiment. As in the case of the third embodiment (FIG. 13), a light source side laminated portion 180 is constituted by the mounting layer 31, the insulating layer 41, and the mounting layer 32 in FIG. 2. Specifically, the light source side laminated portion 180 includes the light emitting element array 124, a driving wiring unit 182, and a driving circuit 173.

The driving wiring unit 182 includes an aggregate of wiring for driving each of the light emitting elements E01 to E16. The driving wiring unit 172 connects each of the cathode sides of the light emitting elements E01 to E16 to the driving circuit 173. The driving wiring unit 172 connects the anode sides of the light emitting elements E01 to E16 to a switch or a DC-DC converter (not illustrated). Anode wiring is not depicted for the convenience of illustration.

Common linear wiring 184 is connected to each of the cathode sides of four light emitting elements E01, E05, E09, and E13. In addition, common linear wiring 185 is connected to each of the cathode sides of four light emitting elements E02, E06, E10, and E14. In addition, common linear wiring 186 is connected to each of the cathode sides of four light emitting elements E04, E07, E12, and E15. In addition, common linear wiring 187 is connected to each of the cathode sides of four light emitting elements E04, E08, E12, and E16.

In addition, each piece of meander-shaped wiring 190, 191, 192, and 193 is connected to the cathode side of another light emitting element not illustrated. Each piece of meander-shaped wiring 190 to 193 extends in a zigzag shape while meandering along the X-direction (to an X1 side or an X2 side). Each piece of meander-shaped wiring 190 to 193 is formed by alternately combining a first line segment extending in the X-direction and a second line segment extending in the Y-direction.

The driving wiring unit 182 may thus include the pieces of meander-shaped wiring 190 to 193 that extend in a zigzag shape while meandering in one of the X-direction and the Y-direction. Actions and effects similar to those in the case of the third embodiment (that is, the effect of suppressing electromagnetic noise) are obtained even in the case of such uniaxial meandering.

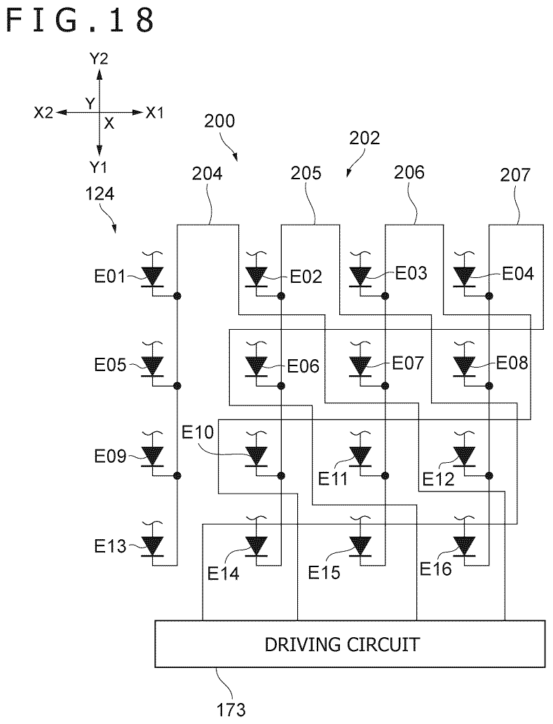

FIG. 18 is a diagram illustrating a circuit structure in a fourth modification of the third embodiment. As in the case of the third embodiment (FIG. 13), a light source side laminated portion 200 is constituted by the mounting layer 31, the insulating layer 41, and the mounting layer 32 in FIG. 2. Specifically, the light source side laminated portion 200 includes the light emitting element array 124, a driving wiring unit 202, and a driving circuit 173.

The driving wiring unit 202 includes an aggregate of wiring for driving each of the light emitting elements E01 to E16. The driving wiring unit 202 connects each of the cathode sides of the light emitting elements E01 to E16 to the driving circuit 173. The driving wiring unit 202 connects the anode sides of the light emitting elements E01 to E16 to a switch or a DC-DC converter (not illustrated). Anode wiring is not depicted for the convenience of illustration.

Common meander-shaped wiring 204 is connected to each of the cathode sides of four light emitting elements E01, E05, E09, and E13. In addition, common meander-shaped wiring 205 is connected to each of the cathode sides of four light emitting elements E02, E06, E10, and E14. In addition, common meander-shaped wiring 206 is connected to each of the cathode sides of four light emitting elements E03, E07, E11, and E15. In addition, common meander-shaped wiring 207 is connected to each of the cathode sides of four light emitting elements E04, E08, E12, and E16. Each piece of meander-shaped wiring 204 to 207 extends in a zigzag shape while meandering in the X-direction (to the X1 side or the X2 side) and the Y-direction (to a Y1 side or a Y2 side). Each piece of meander-shaped wiring 204 to 207 is formed by alternately combining a first line segment extending in the X-direction and a second line segment extending in the Y-direction.

The driving wiring unit 202 may thus include the meander-shaped wiring 204 to 207 that extends in a zigzag shape while meandering in both the X-direction and the Y-direction. Actions and effects similar to those in the case of the third embodiment (that is, the effect of suppressing electromagnetic noise) are obtained even in the case of such biaxial meandering.

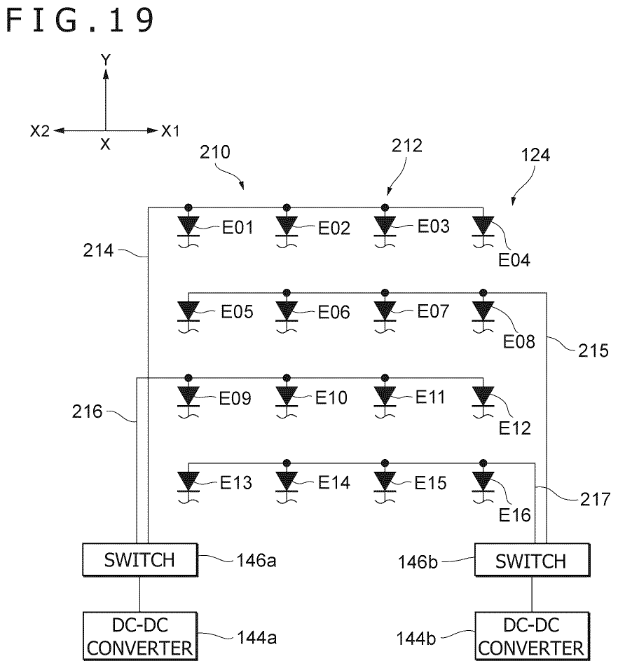

FIG. 19 is a diagram illustrating a circuit structure in a fifth modification of the third embodiment. As in the case of the third embodiment (FIG. 13), a light source side laminated portion 210 is constituted by the mounting layer 31, the insulating layer 41, and the mounting layer 32 in FIG. 2. Specifically, the light source side laminated portion 210 includes the light emitting element array 124, a driving wiring unit 212, a pair of DC-DC converters 144a and 144b, and a pair of switches 146a and 146b.

The driving wiring unit 212 includes an aggregate of wiring for driving each of the light emitting elements E01 to E16. The driving wiring unit 212 connects each of the anode sides of light emitting elements E01 to E04 and E09 to E13 to one switch 146a, and connects each of the anode sides of light emitting elements E05 to E08 and E13 to E16 to the other switch 146b. The driving wiring unit 212 connects the cathode sides of the light emitting elements E01 to E16 to a driving circuit (not illustrated). Cathode wiring is not depicted for the convenience of illustration.

Common anode wiring 214 is connected to each of the anode sides of the four light emitting elements E01 to E04. In addition, common anode wiring 215 is connected to each of the anode sides of the four light emitting elements E05 to E08. In addition, common anode wiring 216 is connected to each of the anode sides of the four light emitting elements E09 to E12. In addition, common anode wiring 217 is connected to each of the anode sides of the four light emitting elements E13 to E16.

Here, the four pieces of anode wiring 214 to 217 include a plurality of pieces of linear wiring extending in the X-direction. The two pieces of anode wiring 214 and 216 are configured such that current flows from the X2 side to the X1 side. The two pieces of anode wiring 215 and 217 are configured such that current flows from the X1 side to the X2 side.

Thus, in a case where the driving wiring unit 212 includes a plurality of pieces of linear wiring (anode wiring 214 to 217 in this case) extending in parallel with one direction (X-direction in this case) as viewed in plan from the lamination direction (that is, the Z-direction), one or more pieces of anode wiring 214 and 216 among the pieces of anode wiring 214 to 217 may be configured such that a direction of current flowing through the one or more pieces of anode wiring 214 and 216 is opposite from a direction of current flowing through the remaining pieces of anode wiring 215 and 217. It is thereby possible to cancel noise occurring from the light emitting elements E01 to E16.

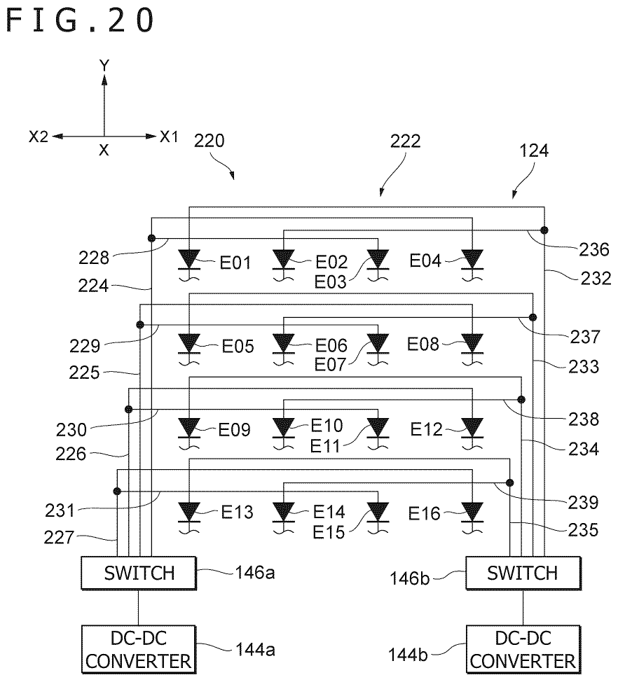

FIG. 20 is a diagram illustrating a circuit structure in a sixth modification of the third embodiment. As in the case of the third embodiment (FIG. 13), a light source side laminated portion 220 is constituted by the mounting layer 31, the insulating layer 41, and the mounting layer 32 in FIG. 2. Specifically, the light source side laminated portion 220 includes the light emitting element array 124, a driving wiring unit 222, a pair of DC-DC converters 144a and 144b, and a pair of switches 146a and 146b.

The driving wiring unit 222 includes an aggregate of wiring for driving each of the light emitting elements E01 to E16. The driving wiring unit 222 connects each of the anode sides of light emitting elements E03 to E04, E07 to E08, E11 to E12, and E15 to E16 to one switch 146a, and connects each of the anode sides of light emitting elements E01 to E02, E05 to E06, E09 to E10, and E13 to E14 to the other switch 146b. The driving wiring unit 222 connects the cathode sides of the light emitting elements E01 to E16 to a driving circuit (not illustrated). Cathode wiring is not depicted for the convenience of illustration.

Individual pieces of anode wiring 224, 225, 226, and 227 are respectively connected to the anode sides of four light emitting elements E04, E08, E12, and E16. In addition, pieces of branch wiring 228, 229, 230, and 231 branched from pieces of anode wiring 224 to 227 are respectively connected to the anode sides of four light emitting elements E03, E07, E11, and E15.

Individual pieces of anode wiring 232, 233, 234, and 235 are respectively connected to the anode sides of four light emitting elements E01, E05, E09, and E13. In addition, pieces of branch wiring 236, 237, 238, and 239 branched from pieces of anode wiring 232 to 235 are respectively connected to the anode sides of four light emitting elements E03, E07, E11, and E15.

The eight pieces of anode wiring 224 to 227 and 232 to 235 include a plurality of pieces of linear wiring extending in the X-direction. The four pieces of anode wiring 224 to 227 are configured such that current flows from the X2 side to the X1 side. The four pieces of anode wiring 232 to 235 are configured such that current flows from the X1 side to the X2 side.

The eight pieces of branch wiring 228 to 231 and 236 to 239 include a plurality of pieces of linear wiring extending in the X-direction. The four pieces of branch wiring 228 to 231 are configured such that current flows from the X2 side to the X1 side. The four pieces of branch wiring 236 to 239 are configured such that current flows from the X1 side to the X2 side.

Thus, in a case where the driving wiring unit 222 includes a plurality of pieces of linear wiring (the pieces of anode wiring 224 to 227 and 232 to 235 and the pieces of branch wiring 228 to 231 and 236 to 239 in this case) extending in parallel with one direction (X-direction in this case) as viewed in plan from the lamination direction (that is, the Z-direction), the pieces of anode wiring 224 to 227 (or the pieces of branch wiring 228 to 231) may be configured such that a direction of current flowing through the pieces of anode wiring 224 to 227 (or the pieces of branch wiring 228 to 231) is opposite from a direction of current flowing through the remaining pieces of anode wiring 232 to 235 (or the pieces of branch wiring 236 to 239). As in the case of the fifth modification, this configuration can also cancel noise occurring from the light emitting elements E01 to E16.

In FIG. 15, FIG. 19, and FIG. 20, examples of relations between the pieces of anode wiring of the light emitting elements E01 to E16 have been made. However, in addition to this or in place of this, the cathode lines or a combination of the anode lines and the cathode lines may be configured to have the above-described relation. In addition, in FIGS. 16 to 18, examples of relation between the pieces of cathode wiring of the light emitting elements E01 to E16 have been made. However, in addition to this or in place of this, the anode lines or a combination of the cathode lines and the anode lines may be configured to have the above-described relation.

### Fourth Embodiment

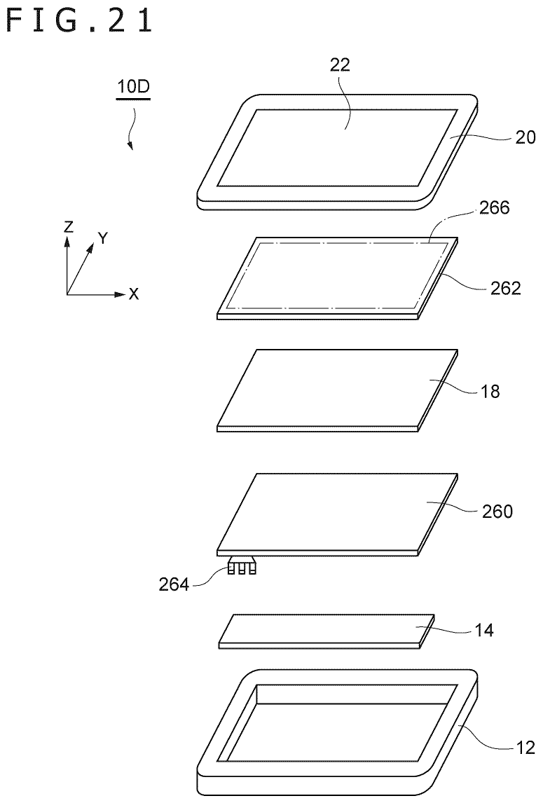

A light source substrate 260 in a fourth embodiment of the present disclosure will next be described with reference to FIGS. 21 to 24.

### General Configuration

FIG. 21 is an exploded perspective view of a display device 10D incorporating the light source substrate 260 in the fourth embodiment. This display device 10D is formed by laminating a back cover 12, a control board 14, the light source substrate 260, a display panel 18, a sensor substrate 262, and a front cover 20 from a back side in order.

The light source substrate 260 is a multilayer substrate that exerts at least a light emitting function and a magnetic field generating function. The light emitting function is a function of emitting illumination light from a back surface to a front surface of the display panel 18. The magnetic field generating function is a function of generating and outputting an alternating magnetic field. Incidentally, one flexible cable 264 is electrically connected to the light source substrate 260 via a connector not illustrated or compression bonding. The light source substrate 260 is connected to a connector (not illustrated) on the control board 14 via the flexible cable 264.

The sensor substrate 262 is a multilayer substrate that exerts at least a pen detecting function. The pen detecting function is a function of detecting a position indicated within a detection area 266 through an electromagnetic induction type electronic pen. A detecting coil group for detecting a signal from the electronic pen is mounted in the sensor substrate 262. Incidentally, a capacitive type touch sensor formed by arranging a plurality of sensor electrodes in a planar shape may be further mounted in the sensor substrate 262.

### Configuration of Light Source Substrate 260

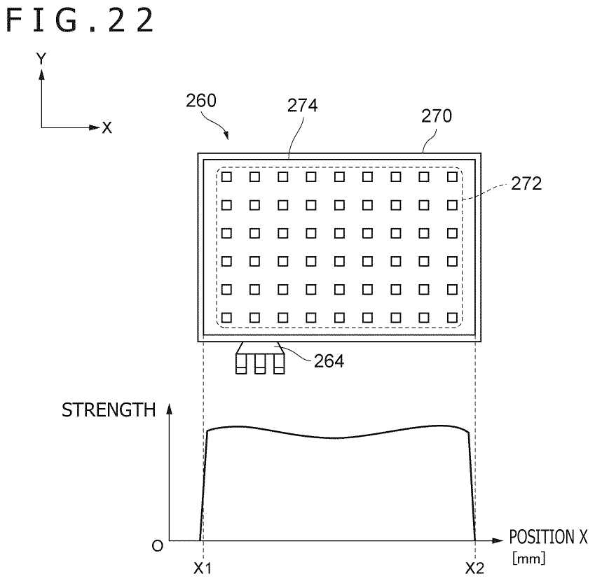

FIG. 22 is a schematic plan perspective view of the light source substrate 260 illustrated in FIG. 21. The light source substrate 260 includes a plurality of mounting layers mounted with a light emitting element array 272 including a plurality of light emitting elements and a driving wiring unit of the light emitting element array 272 and one or more insulating layers for insulating adjacent layers of the plurality of mounting layers from each other. In the example of FIG. 22, this light source substrate 260 includes an insulative base material 270; the light emitting element array 272 provided on one principal surface of the base material 270; and one sending coil 274 (or a power coil) provided on another principal surface of the base material 270.

The light emitting element array 272 is an aggregate of light emitting elements (illustrated as squares) arranged in a lattice manner with the X-direction and the Y-direction as two axes. The light emitting elements are LEDs, for example, and may be mini LEDs having a diameter of roughly 100 to 200 μm. The driving wiring unit of the light emitting element array 272 is not illustrated.

The sending coil 274 is a coil for generating an alternating magnetic field used to detect a signal from the electromagnetic induction type electronic pen. The sending coil 274 has a rectangular shape, for example, and is provided so as to surround the whole of the light emitting element array 272. A graph below of the drawing illustrates a magnetic field strength distribution. An axis of abscissas of the graph indicates position (unit: mm), and an axis of ordinates of the graph indicates magnetic field strength. In ranges X1 to X2 in which the sending coil 274 is present, a substantially uniform strength distribution is obtained, though there is a slight decrease in a central part of the sending coil 274.

### Actions and Effects

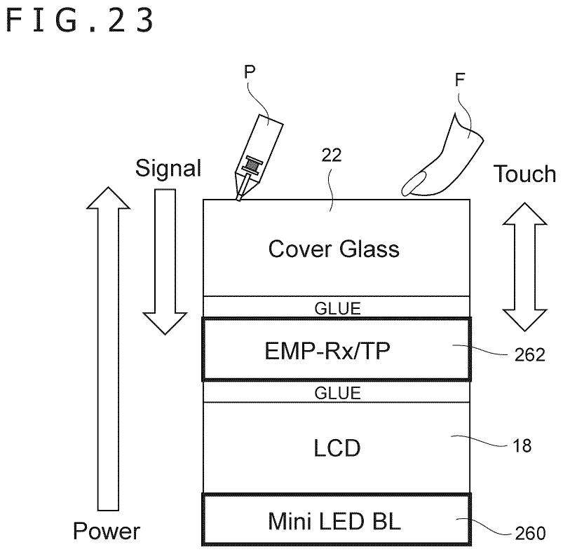

FIG. 23 is a diagram schematically illustrating actions and effects of the device configuration of FIG. 22. When an electronic pen P approaches the protective panel 22 while the light source substrate 260 is generating and outputting an alternating magnetic field, a pen signal is transmitted from the electronic pen P through electromagnetic induction. The sensor substrate 262 detects the pen signal from the electronic pen P. The electronic pen P is thereby detected. In addition, when a touch sensor is incorporated in the sensor substrate 262, a touch of a finger F is also detected.

Thus, the light source substrate 260 in the fourth embodiment includes a plurality of mounting layers mounted with the light emitting element array 272 including a plurality of light emitting elements and a driving wiring unit of the light emitting element array 272 and one or more insulating layers for insulating adjacent layers of the plurality of mounting layers from each other. The plurality of mounting layers include a coil mounting layer provided with one or more sending coils 274 for generating an alternating magnetic field used to detect a signal from the electromagnetic induction type electronic pen.

In addition, the display device 10D in the fourth embodiment includes the light source substrate 260 described above; the non-emissive display panel 18 provided on the upper side of the light source substrate 260; and the sensor substrate 262 provided on the upper side of the display panel 18 and mounted with a detecting coil group for detecting a signal from the electromagnetic induction type electronic pen.

When the whole of the functions of the EMR sensor is fused into the light source substrate, for example, an increase in the number of mounting layers or interference between pieces of wiring can be a problem. Accordingly, an optimization design of hardware is achieved by fusing a part of the functions of the EMR sensor into the light source substrate as in the fourth embodiment.

### Modifications

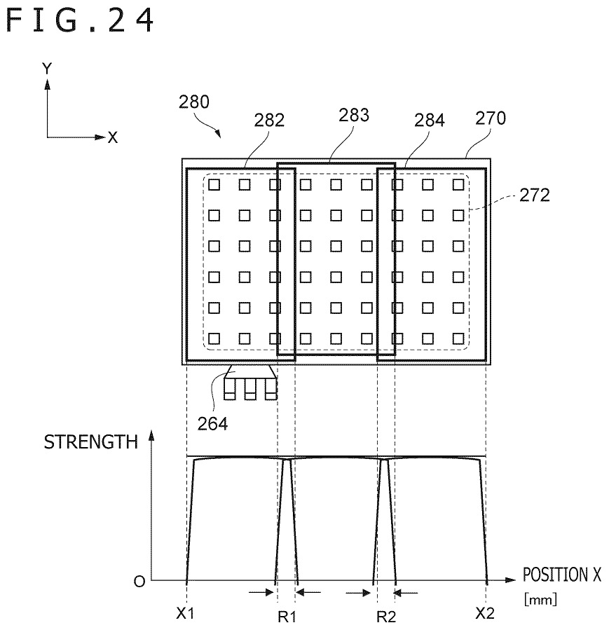

FIG. 24 is a schematic plan perspective view of a light source substrate 280 in a modification of the fourth embodiment. In the example of FIG. 24, the light source substrate 280 includes a plurality of sending coils 282, 283, and 284 in addition to the base material 270 and the light emitting element array 272.

The sending coils 282, 283, and 284 are coils for generating an alternating magnetic field used to detect a signal from an electromagnetic induction type electronic pen. The sending coils 282 to 284 have a rectangular shape, for example, and have substantially the same shape. The sending coil 282 is provided so as to surround a left side region (⅓ of an entire region) of the light emitting element array 272. The sending coil 283 is provided so as to surround a central region (⅓ of the entire region) of the light emitting element array 272. The sending coil 284 is provided so as to surround a right side region (⅓ of the entire region) of the light emitting element array 272. The sending coils 282 and 283 are arranged so as to partly overlap each other in the X-direction. The sending coils 283 and 284 are arranged so as to partly overlap each other in the X-direction.

As in the case of FIG. 22, a graph below the drawing indicates a magnetic field strength distribution. As is understood from FIG. 24, a substantially uniform strength distribution is obtained in ranges X1 to X2 in which the sending coils 282 to 284 are present. Here, an adjustment is made such that the strength is substantially constant in an overlap range R1 of the sending coils 282 and 283 and an overlap range R2 of the sending coils 283 and 284.

Actions and effects similar to those in the case of the fourth embodiment (FIG. 22) (that is, uniformization of the magnetic field strength) are obtained also when a configuration is thus adopted so as to surround the whole of the light emitting element array 272 as viewed in plan from the lamination direction by using the plurality of sending coils 282 to 284 (three sending coils in this case).

### Fifth Embodiment

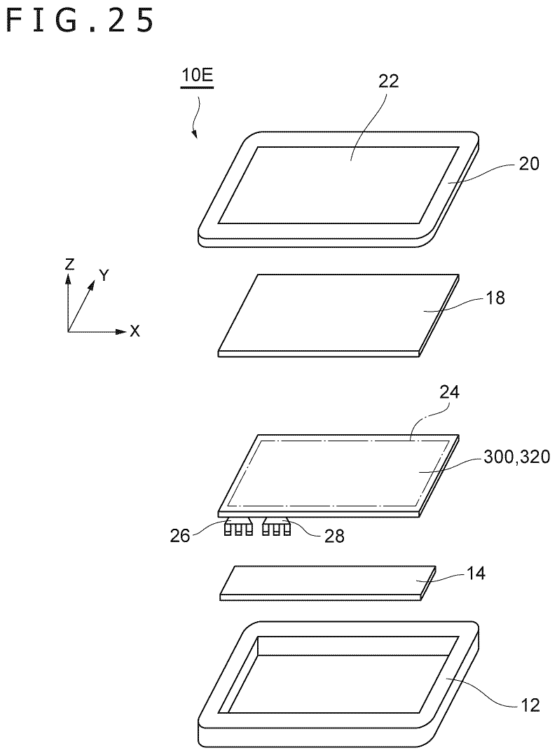

Light source-equipped sensor substrates 300 and 320 in a fifth embodiment of the present disclosure will next be described with reference to FIGS. 25 to 27.

### General Configuration

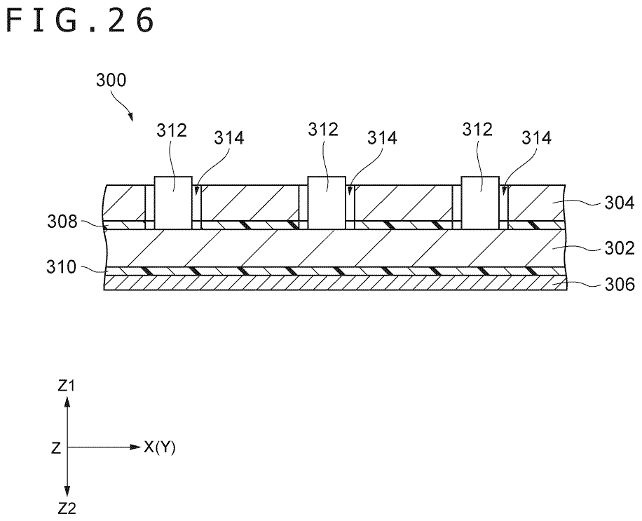

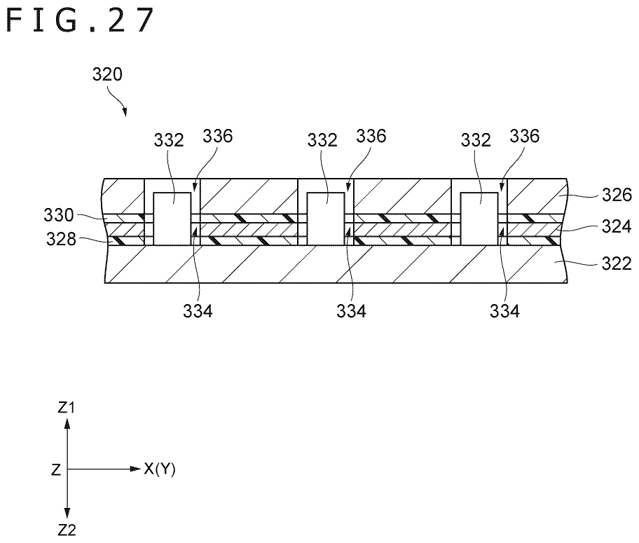

FIG. 25 is an exploded perspective view of a display device 10E incorporating the light source-equipped sensor substrate 300 in the fifth embodiment. This display device 10E is formed by laminating a back cover 12, a control board 14, the light source-equipped sensor substrate 300, a display panel 18, and a front cover 20 from a back side in order. The light source-equipped sensor substrate 300 has a structure different from that in the case of the light source-equipped sensor substrate 16 (FIG. 1) in the first embodiment. Incidentally, the display device 10E may include the light source-equipped sensor substrate 320 (FIG. 27) in place of the light source-equipped sensor substrate 300 (FIG. 26).

### Configuration of Light Source-Equipped Sensor Substrates 300 and 320

FIG. 26 is a schematic sectional view of the light source-equipped sensor substrate 300 illustrated in FIG. 25. As in the case of the first embodiment (FIG. 2 and FIG. 3), in a lamination direction of the light source-equipped sensor substrate 300 (that is, the Z-direction), a side close to the display panel 18 will be referred to as a Z1 side, and a side far from the display panel 18 will be referred to as a Z2 side. This light source-equipped sensor substrate 300 includes a first printed board 302, a second printed board 304, and a shield plate 306.

The light source-equipped sensor substrate 300 is formed by laminating two printed boards, that is, the first printed board 302 and the second printed board 304. The second printed board 304 is bonded to the Z1 side of the first printed board 302 via a bonding layer 308. The shield plate 306 is bonded to the Z2 side of the first printed board 302 via a bonding layer 310.

The first printed board 302 is a printed circuit board (PCB) or a printed wiring board (PWB) having a light emitting function. A plurality of light emitting elements 312 arranged two-dimensionally (that is, a light emitting element array) are mounted on the first printed board 302. In the example of FIG. 26, three light emitting elements 312 are provided to a principal surface on the Z1 side of the first printed board 302.

The second printed board 304 is a PCB or a printed wiring board (PWB) having an electronic pen detecting function. The second printed board 304 is mounted with a coil wiring unit for detecting an electromagnetic induction type electronic pen. In a principal surface of the second printed board 304, a plurality of window portions 314 (three window portions 314 in the example of FIG. 26) are formed at a position(s) corresponding to one or the plurality of light emitting elements 312. As is understood from FIG. 26, the first printed board 302 and the second printed board 304 are laminated to each other in a state in which the light emitting elements 312 are exposed via the window portions 314.

The shield plate 306 is a member for shielding from electromagnetic noise, the member being formed of metal such as silver, copper, or aluminum. This shield plate 306 may be excluded from the laminated configuration of the light source-equipped sensor substrate 300 as necessary.

FIG. 27 is a schematic sectional view illustrating another configuration of the light source-equipped sensor substrate 320 in FIG. 25. This light source-equipped sensor substrate 320 includes a first printed board 322, a shield plate 324, and a second printed board 326 in this order from the Z2 side to the Z1 side.

The light source-equipped sensor substrate 320 is formed by laminating the two printed boards, that is, the first printed board 322 and the second printed board 326 in a state in which the shield plate 324 is interposed therebetween. The shield plate 324 is bonded to the Z1 side of the first printed board 322 via a bonding layer 328. The second printed board 326 is bonded to the Z1 side of the shield plate 324 via a bonding layer 330.

The first printed board 322 is a PCB or a printed wiring board (PWB) having a light emitting function. A plurality of light emitting elements 332 arranged two-dimensionally (that is, a light emitting element array) are mounted on the first printed board 322. In the example of FIG. 27, three light emitting elements 332 are provided to a principal surface on the Z1 side of the first printed board 322.

The shield plate 324 is a member for shielding from electromagnetic noise, the member being formed of metal such as silver, copper, or aluminum. In a principal surface of the shield plate 324, a plurality of window portions 334 (three window portions 334 in the example of FIG. 27) are formed at a position(s) corresponding to one or the plurality of light emitting elements 332.

The second printed board 326 is a PCB or a printed wiring board (PWB) having an electronic pen detecting function. The second printed board 326 is mounted with a coil wiring unit for detecting a signal from an electromagnetic induction type electronic pen. In a principal surface of the second printed board 326, a plurality of window portions 336 (three window portions 336 in the example of FIG. 27) are formed at a position(s) corresponding to one or the plurality of light emitting elements 332. As is understood from FIG. 27, the first printed board 322, the shield plate 324, and the second printed board 326 are laminated to each other in a state in which the light emitting elements 332 are exposed via the window portions 334 and 336.

### Effects of Fifth Embodiment

As described above, the light source-equipped sensor substrate 300 (320) in the fifth embodiment includes the first printed board 302 (322) mounted with the plurality of light emitting elements 312 (332) arranged two-dimensionally and the second printed board 304 (326) mounted with the coil wiring unit for detecting the electromagnetic induction type electronic pen. In the second printed board 304 (326), the plurality of window portions 314 (334) are formed at the positions corresponding to the light emitting elements 312 (332), and the first printed board 302 (322) and the second printed board 304 (326) are laminated to each other in a state in which the light emitting elements 312 (332) are exposed via the window portions 314 (334 and 336).

With such a configuration, both the light emitting elements 312 (332) and the coil wiring unit can be mounted on the Z1 side. It is consequently possible to enhance both electronic pen detection sensitivity and emission intensity of the light emitting elements 312 (332).

### Description of Four Types of Sensor Substrates SB1 to SB4

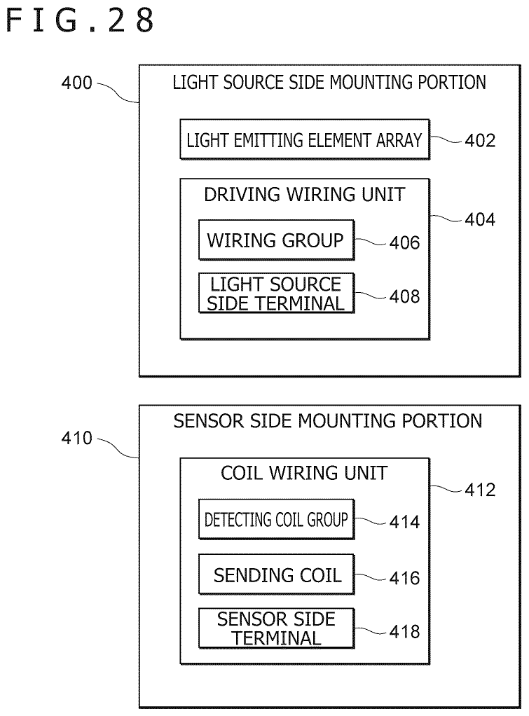

Four types of light source-equipped sensor substrates SB1 to SB4 in the present disclosure will next be described with reference to FIGS. 28 to 41.

FIG. 28 is a diagram schematically illustrating respective configurations of a light source side mounting portion 400 and a sensor side mounting portion 410. The light source side mounting portion 400 includes a light emitting element array 402 and a driving wiring unit 404 (more specifically, a wiring group 406 and a light source side terminal 408). The sensor side mounting portion 410 includes a coil wiring unit 412 (more specifically, a detecting coil group 414, a sending coil 416, and a sensor side terminal 418).

### First Type

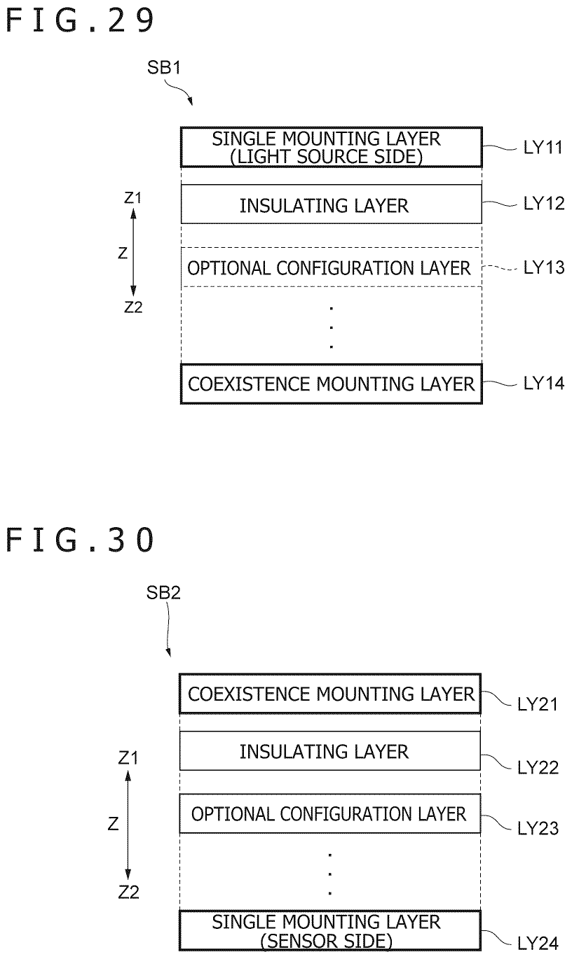

FIG. 29 is a diagram schematically illustrating a laminated structure possessed by the light source-equipped sensor substrate SB1 of the first type. The light source-equipped sensor substrate SB1 is formed by sequentially laminating a single mounting layer LY11, an insulating layer LY12, an optional configuration layer LY13, and a coexistence mounting layer LY14 from the Z1 side to the Z2 side. The configuration of FIG. 2 in the first to third embodiments among the embodiments and the modifications described above corresponds to the first type.

The single mounting layer LY11 is a mounting layer that is provided with a part of the light source side mounting portion 400 but is not provided with the configuration of the sensor side mounting portion 410. More specifically, the single mounting layer LY11 is provided with either only the light emitting element array 402 or the light emitting element array 402 and a part of the driving wiring unit 404.

The insulating layer LY12 is configured to electrically insulate the single mounting layer LY11 and the optional configuration layer LY13 from each other in a case where the optional configuration layer LY13 is interposed. The insulating layer LY12 is configured to electrically insulate the single mounting layer LY11 and the coexistence mounting layer LY14 from each other in a case where the optional configuration layer LY13 is not interposed.

The optional configuration layer LY13 may be one layer or two layers or more, or may not exist at all. The optional configuration layer LY13 is either a single mounting layer including a part of the light source side mounting portion 400, a single mounting layer including a part of the sensor side mounting portion 410, [a coexistence mounting layer including a part of the light source side mounting portion 400 and a part of the light source side mounting portion 400, or an insulating layer.

The coexistence mounting layer LY14 is a mounting layer that is provided with a part of the light source side mounting portion 400 and at least a part of the sensor side mounting portion 410.

More specifically, the coexistence mounting layer LY14 is provided with either a part of the driving wiring unit 404 and a part of the coil wiring unit 412, the whole of the driving wiring unit 404 and a part of the coil wiring unit 412, or the whole of the driving wiring unit 404 and the whole of the coil wiring unit 412.

### Second Type

FIG. 30 is a diagram schematically illustrating a laminated structure possessed by the light source-equipped sensor substrate SB2 of the second type. The light source-equipped sensor substrate SB2 is formed by sequentially laminating a coexistence mounting layer LY21, an insulating layer LY22, an optional configuration layer LY23, and a single mounting layer LY24 from the Z1 side to the Z2 side. The configuration of FIG. 3 in the first to third embodiments among the embodiments and the modifications described above corresponds to the second type.

The coexistence mounting layer LY21 is a mounting layer that is provided with at least a part of the light source side mounting portion 400 and a part of the sensor side mounting portion 410. More specifically, the coexistence mounting layer LY21 is provided with either the light emitting element array 402 and a part of the coil wiring unit 412, the light emitting element array 402, a part of the driving wiring unit 404, and a part of the coil wiring unit 412, or the light emitting element array 402, the whole of the driving wiring unit 404, and a part of the coil wiring unit 412.

The insulating layer LY22 is configured to electrically insulate the coexistence mounting layer LY21 and the optional configuration layer LY23 from each other in a case where the optional configuration layer LY23 is interposed. The insulating layer LY22 is configured to electrically insulate the coexistence mounting layer LY21 and the single mounting layer LY24 from each other in a case where the optional configuration layer LY23 is not interposed.

The optional configuration layer LY23 may be one layer or two layers or more, or may not exist at all. The optional configuration layer LY23 is either a single mounting layer including a part of the light source side mounting portion 400, a single mounting layer including a part of the sensor side mounting portion 410, a coexistence mounting layer including a part of the light source side mounting portion 400 and a part of the light source side mounting portion 400, or an insulating layer.

The single mounting layer LY24 is a mounting layer that is provided with a part of the sensor side mounting portion 410 but is not provided with the configuration of the light source side mounting portion 400. More specifically, the single mounting layer LY24 is provided with a part of the coil wiring unit 412.

### Third Type

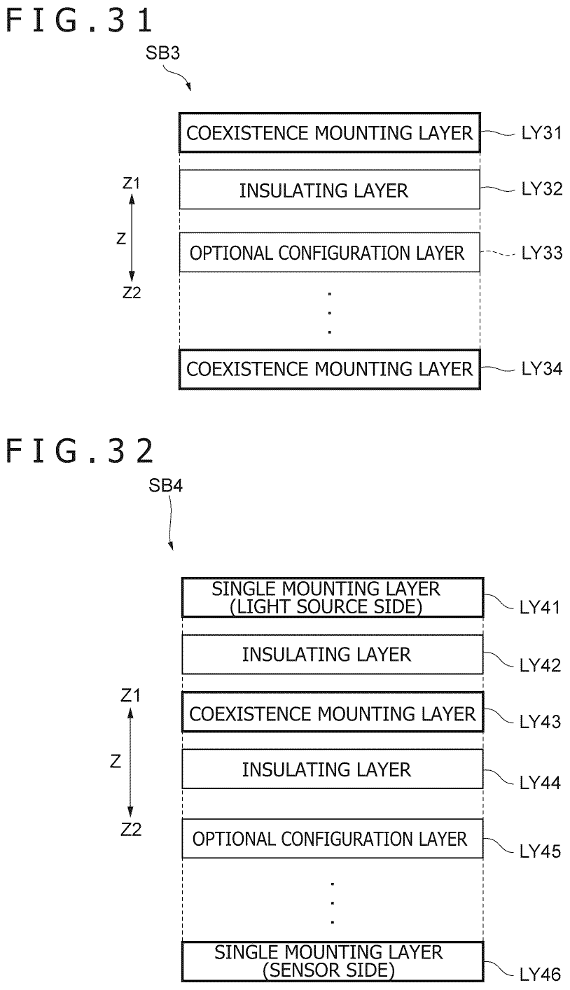

FIG. 31 is a diagram schematically illustrating a laminated structure possessed by the light source-equipped sensor substrate SB3 of the third type. The light source-equipped sensor substrate SB3 is formed by sequentially laminating a coexistence mounting layer LY31, an insulating layer LY32, an optional configuration layer LY33, and a coexistence mounting layer LY34 from the Z1 side to the Z2 side.

The coexistence mounting layer LY31 is a mounting layer that is provided with a part of the light source side mounting portion 400 and a part of the sensor side mounting portion 410. More specifically, the coexistence mounting layer LY31 is provided with either the light emitting element array 402 and a part of the coil wiring unit 412 or the light emitting element array 402, a part of the driving wiring unit 404, and a part of the coil wiring unit 412.

The insulating layer LY32 is configured to electrically insulate the coexistence mounting layer LY31 and the optional configuration layer LY33 from each other in a case where the optional configuration layer LY33 is interposed. The insulating layer LY32 is configured to electrically insulate the coexistence mounting layer LY31 and the coexistence mounting layer LY34 from each other in a case where the optional configuration layer LY33 is not interposed.

The optional configuration layer LY33 may be one layer or two layers or more, or may not exist at all. The optional configuration layer LY33 is either a single mounting layer including a part of the light source side mounting portion 400, a single mounting layer including a part of the sensor side mounting portion 410, a coexistence mounting layer including a part of the light source side mounting portion 400 and a part of the light source side mounting portion 400, or an insulating layer.

The coexistence mounting layer LY34 is a mounting layer that is provided with a part of the light source side mounting portion 400 and a part of the sensor side mounting portion 410. More specifically, the coexistence mounting layer LY34 is provided with a part of the driving wiring unit 404 and a part of the coil wiring unit 412.

### Fourth Type

FIG. 32 is a diagram schematically illustrating a laminated structure possessed by the light source-equipped sensor substrate SB4 of the fourth type. The light source-equipped sensor substrate SB4 is formed by sequentially laminating a single mounting layer LY41, an insulating layer LY42, a coexistence mounting layer LY43, an insulating layer LY44, an optional configuration layer LY45, and a single mounting layer LY46 from the Z1 side to the Z2 side. Incidentally, the order of the lamination is not limited to the example illustrated in FIG. 32. For example, the order of the coexistence mounting layer LY43 and the optional configuration layer LY45 may be interchanged.

The single mounting layer LY41 is a mounting layer that is provided with a part of the light source side mounting portion 400 but is not provided with the configuration of the sensor side mounting portion 410. More specifically, the single mounting layer LY41 is provided with either only the light emitting element array 402 or the light emitting element array 402 and a part of the driving wiring unit 404.

The insulating layer LY42 is configured to electrically insulate the single mounting layer LY41 and the coexistence mounting layer LY43 from each other.

The coexistence mounting layer LY43 is a mounting layer that is provided with a part of the light source side mounting portion 400 and a part of the sensor side mounting portion 410. More specifically, the coexistence mounting layer LY43 is provided with a part of the driving wiring unit 404 and a part of the coil wiring unit 412.

The insulating layer LY44 is configured to electrically insulate the coexistence mounting layer LY43 and the optional configuration layer LY45 from each other in a case where the optional configuration layer LY45 is interposed. The insulating layer LY44 is configured to electrically insulate the coexistence mounting layer LY43 and the single mounting layer LY46 from each other in a case where the optional configuration layer LY45 is not interposed.

The optional configuration layer LY45 may be one layer or two layers or more, or may not exist at all. The optional configuration layer LY45 is either a single mounting layer including a part of the light source side mounting portion 400, a single mounting layer including a part of the sensor side mounting portion 410, a coexistence mounting layer including a part of the light source side mounting portion 400 and a part of the light source side mounting portion 400, or an insulating layer.

The single mounting layer LY46 is a mounting layer that is provided with a part of the sensor side mounting portion 410 but is not provided with the configuration of the light source side mounting portion 400. More specifically, the single mounting layer LY46 is provided with a part of the coil wiring unit 412.

### Concrete Examples

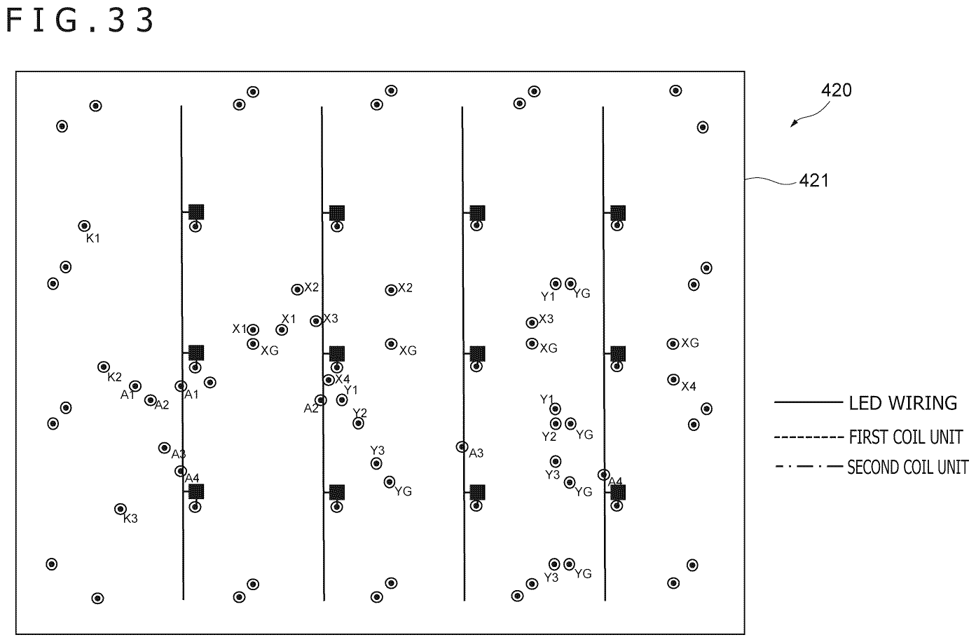

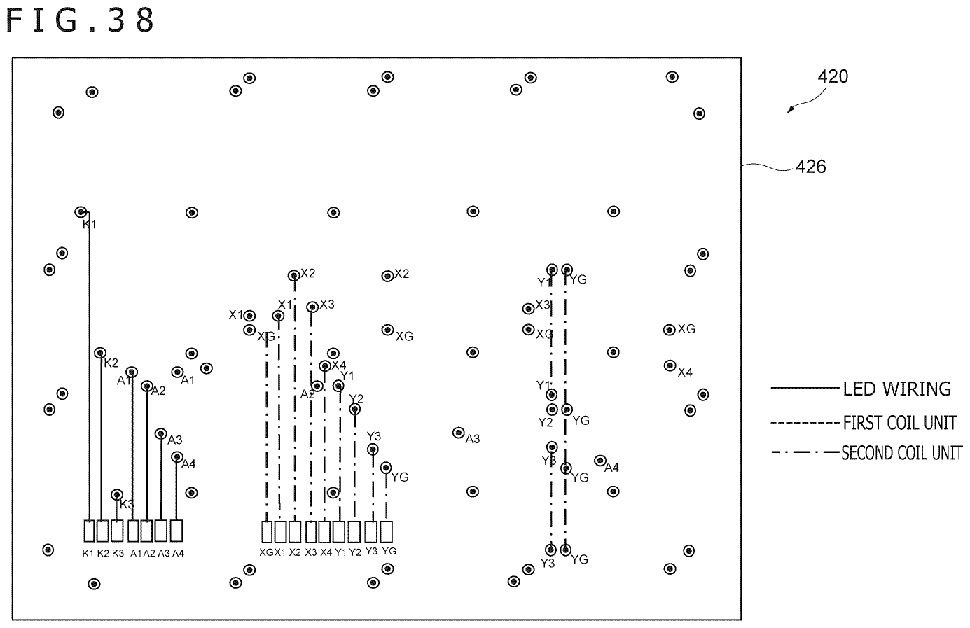

FIGS. 33 to 38 are each a diagram schematically illustrating a laminated structure possessed by a light source-equipped sensor substrate 420 of the first type. Filled squares in FIG. 33 represent positions of the light emitting element array 402 (LED). Unfilled rectangles in FIG. 38 represent positions of the light source side terminal 408 and the sensor side terminal 418. Thick solid lines in the figures represent positions of the wiring group 406 (LED wiring). Broken lines in the figures represent positions of a first part (first coil unit) of the detecting coil group 414. Solid lines in the figures represent positions of a second part (second coil unit) of the detecting coil group 414.

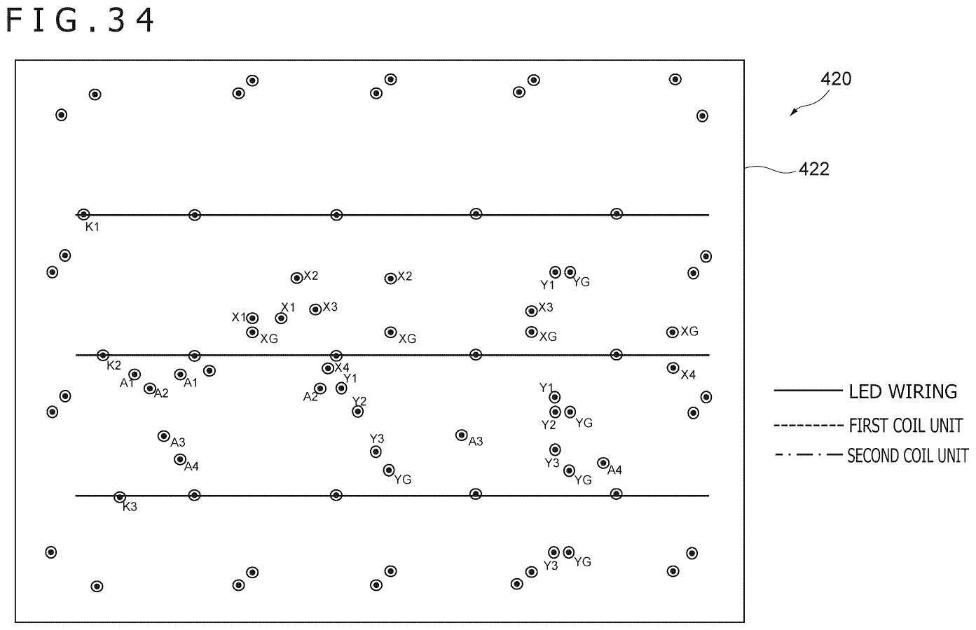

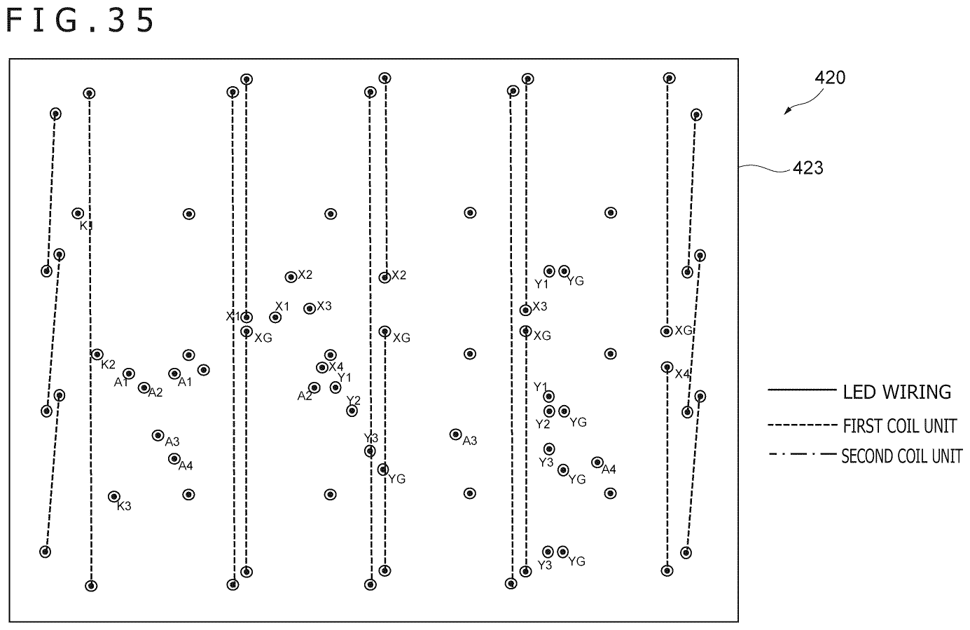

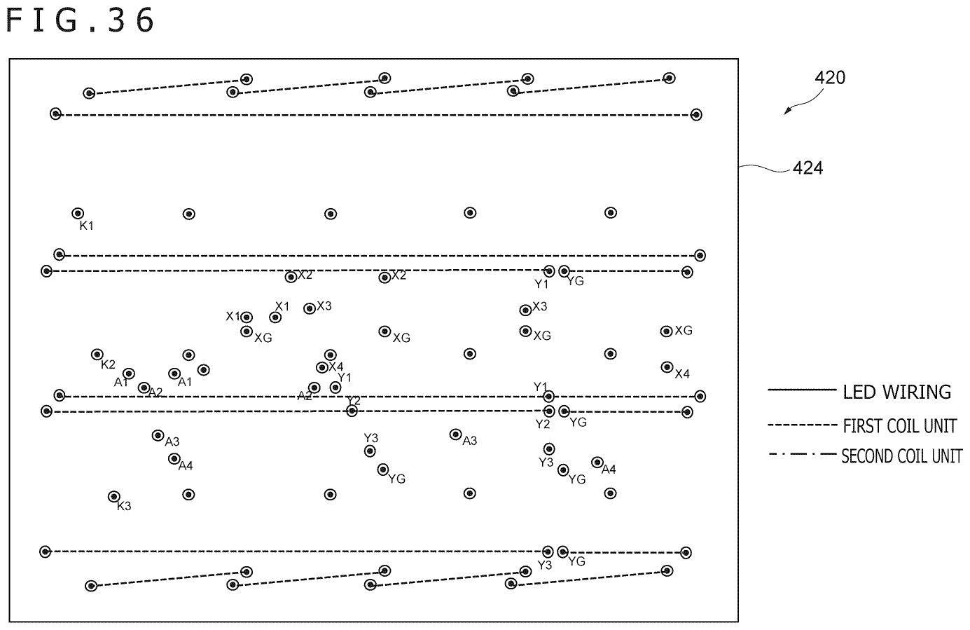

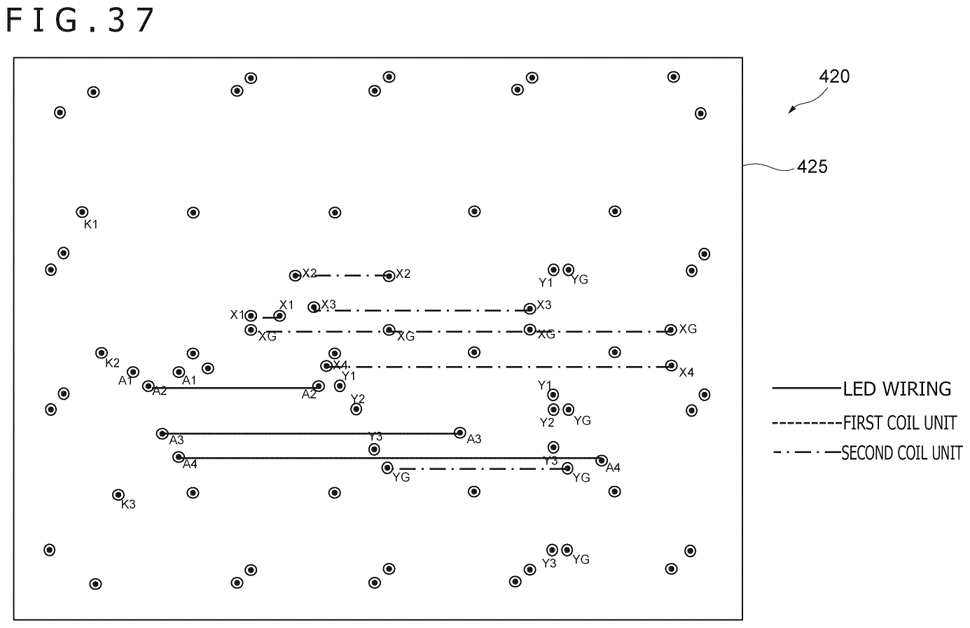

A first mounting layer 421 illustrated in FIG. 33 corresponds to a single mounting layer on the light source side. A second mounting layer 422 illustrated in FIG. 34 corresponds to a single mounting layer on the light source side. A third mounting layer 423 illustrated in FIG. 35 corresponds to a single mounting layer on the sensor side. A fourth mounting layer 424 illustrated in FIG. 36 corresponds to a single mounting layer on the sensor side. A fifth mounting layer 425 illustrated in FIG. 37 corresponds to a coexistence mounting layer. A sixth mounting layer 426 illustrated in FIG. 38 corresponds to a coexistence mounting layer.

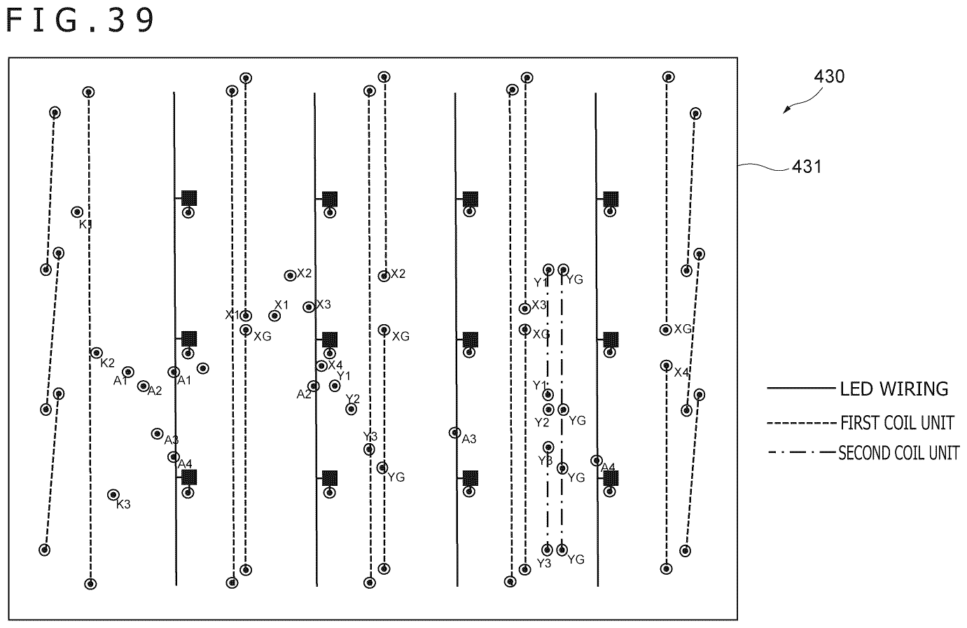

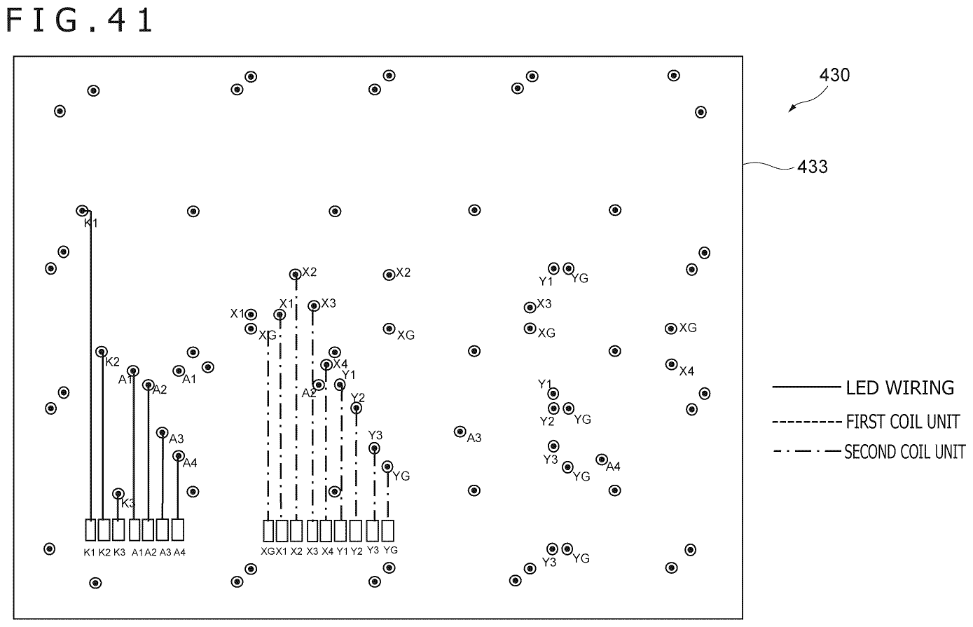

FIGS. 39 to 41 are each a diagram schematically illustrating a laminated structure possessed by a light source-equipped sensor substrate 430 of the third type. Filled squares in FIG. 39 represent positions of the light emitting element array 402 (LED). Unfilled rectangles in FIG. 41 represent positions of the light source side terminal 408 and the sensor side terminal 418. Thick solid lines in the figures represent positions of the wiring group 406 (LED wiring). Broken lines in the figures represent positions of the first part (first coil unit) of the detecting coil group 414. Solid lines in the figures represent positions of the second part (second coil unit) of the detecting coil group 414.

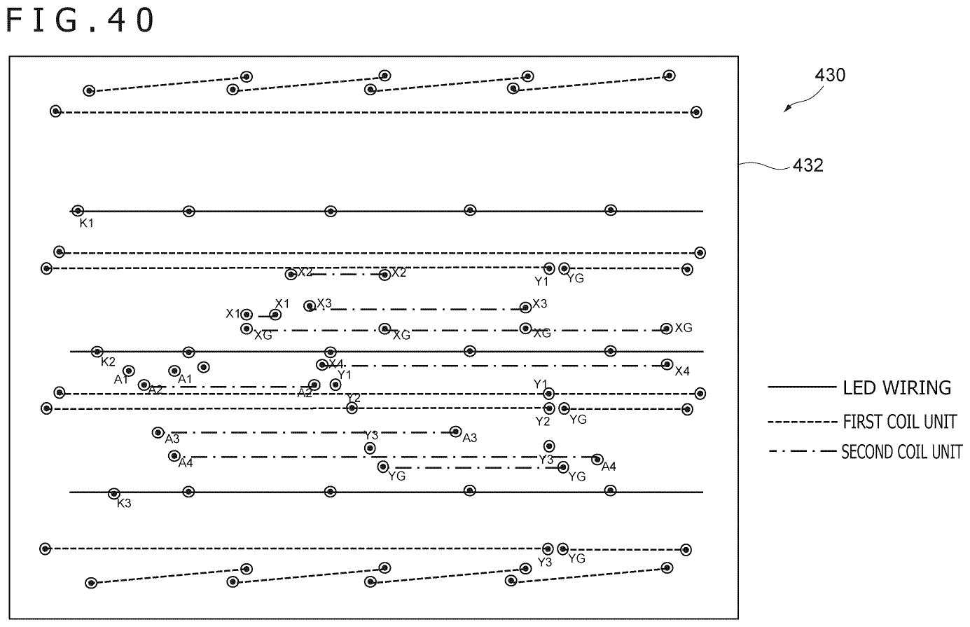

A first mounting layer 431 illustrated in FIG. 39 corresponds to a coexistence mounting layer. A second mounting layer 432 illustrated in FIG. 40 corresponds to a coexistence mounting layer. A third mounting layer 433 illustrated in FIG. 41 corresponds to a coexistence mounting layer.

As described above, the light source-equipped sensor substrates SB1 to SB4 in the first to fourth types include the plurality of mounting layers mounted with the light emitting element array 402 as the plurality of light emitting elements arranged two-dimensionally along the first direction and the second direction intersecting the first direction, the driving wiring unit 404 of the light emitting element array 402, and the coil wiring unit 412 including the detecting coil group 414 for detecting a signal from the electromagnetic induction type electronic pen as well as one or more insulating layers for insulating adjacent layers of the plurality of mounting layers from each other.

With regard to the light source-equipped sensor substrate SB1 of the first type, the plurality of mounting layers include a first mounting layer (LY11) provided with the light emitting element array 402 and a part of the driving wiring unit 404 and a second mounting layer (LY14) provided with a part or the whole of the coil wiring unit 412. Moreover, the second mounting layer (LY14) is further provided with another part of the driving wiring unit 404.

With regard to the light source-equipped sensor substrate SB2 of the second type, the plurality of mounting layers include a first mounting layer (LY21) provided with the light emitting element array 402 and a part of the driving wiring unit 404 and a second mounting layer (LY24) provided with a part of the coil wiring unit 412. Moreover, the first mounting layer (LY21) is further provided with another part of the coil wiring unit 412.

With regard to the light source-equipped sensor substrate SB3 of the third type, the plurality of mounting layers include a first mounting layer (LY31) provided with the light emitting element array 402 and a part of the driving wiring unit 404 and a second mounting layer (LY34) provided with a part of the coil wiring unit 412. Moreover, the first mounting layer (LY31) is further provided with another part of the coil wiring unit 412, and the second mounting layer (LY34) is further provided with another part of the driving wiring unit 404.

With regard to the light source-equipped sensor substrate SB4 of the fourth type, the plurality of mounting layers include a first mounting layer (LY41) provided with the light emitting element array 402 and a part of the driving wiring unit 404, a second mounting layer (LY43) provided with a part of the driving wiring unit 404 and a part of the coil wiring unit 412, and a third mounting layer (LY44) provided with another part of the coil wiring unit 412.

The configuration of each of the first to fourth types described above can improve a degree of freedom of designing the substrates for the position detecting function and the light emitting function.

### Sixth Embodiment

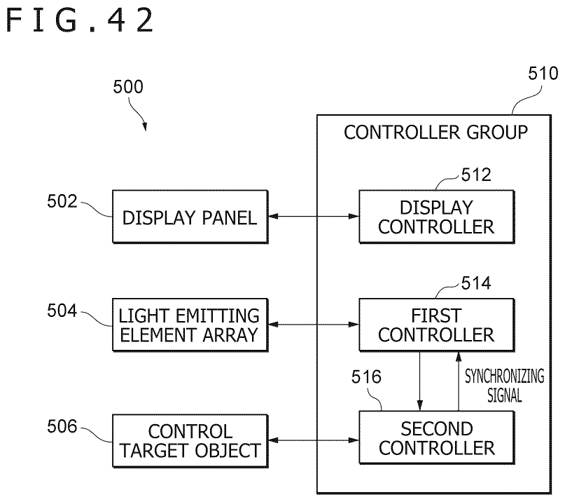

A display device 500 in a sixth embodiment of the present disclosure will next be described with reference to FIGS. 42 to 46.

### Schematic Block Diagram

FIG. 42 is a schematic block diagram of the display device 500 in the sixth embodiment. This display device 500 includes a display panel 502, a light emitting element array 504, a control target object 506, and a controller group 510.

As in the first to fifth embodiments, the display panel 502 is constituted by, for example, a non-emissive display device such as a liquid crystal panel. The display panel 502 drives a plurality of pixels by applying driving voltage to signal lines in a matrix form which signal lines are arranged in a row direction and a column direction. The display panel 18 thereby displays an image or a video within a display region.

As in the first to sixth embodiments, the light emitting element array 504 is an aggregate of light emitting elements arranged in a lattice manner with the X-direction and the Y-direction as two axes. The light emitting elements are LEDs, for example, and may be mini LEDs having a diameter of roughly 100 to 200 μm.

The control target object 506 is an electronic part or an electronic apparatus different from the display panel 502 and the light emitting element array 504. In a case where the electronic pen is of an electromagnetic induction type (or an EMR type), the control target object 506 is a sending coil, a detecting coil group, or the electronic pen. In a case where the electronic pen is of a capacitive type (for example, an active capacitive coupling type; an AES type), the control target object 506 is a capacitive type touch sensor or the electronic pen.

The controller group 510 is constituted by one or a plurality of controllers. Each controller includes a processor and a memory. In the example of FIG. 42, the controller group 510 includes a display controller 512, a first controller 514, and a second controller 516.

The display controller 512 performs display control on the display panel 502. Specifically, the display controller 512 receives image information or video information from a host processor not illustrated, and supplies a driving signal to an X/Y driver of the display panel 502 while performing timing control by generating a video synchronizing signal (for example, a horizontal synchronizing signal and a vertical synchronization signal).

The first controller 514 performs light emission control on the light emitting element array 504. Specifically, the first controller 514 performs a switching operation of switching on and off the light emitting elements or a dimming operation of adjusting the brightness and luminance of the light emitting elements. Cited as an example of a dimming system is analog dimming that adjusts the magnitude of current fed through the light emitting elements or pulse width modulation (PWM) dimming that modulates the pulse width of a current waveform fed through the light emitting elements.

The second controller 516 performs driving control on the control target object 506 which driving control corresponds to functions possessed by the control target object 506. For example, in a case where the control target object 506 is an EMR type sensor substrate, the second controller 516 performs a current output operation of outputting current to the sending coil, a current detecting operation of detecting current flowing through the detecting coils, or a pen detecting operation of detecting the state of the electronic pen. In addition, in a case where the control target object 506 is an AES type sensor substrate, the second controller 516 performs a transmitting operation of transmitting a signal from sensor electrodes, a receiving operation of receiving a signal from the sensor electrodes, or a detecting operation of detecting the state of the electronic pen or the position of a touch.

Here, the first controller 514 and the second controller 516 perform operation timing adjustment control (hereinafter referred to also as timing control) such that a light emission period of the light emitting element array 504 and a driving period of the control target object 506 do not overlap each other. The periods not overlapping each other includes not only a case where the overlapping of the periods is completely unallowable (what is called exclusive control) but also a case where partial overlapping of the periods is allowable within a predetermined range.

The timing control is performed through the exchanging of synchronizing signals, for example. A transmission entity of the synchronizing signals may be either only the first controller 514, only the second controller 516, or both the first controller 514 and the second controller 516. In addition, as for time slots constituting repetitive operation units, various combinations with regard to the time length of the time slots, the ratio of the number of time slots, and the assignment order of the time slots can be selected. In addition, the synchronizing signals may include data necessary for the timing control (for example, the time length, operation mode identifying information, a type of controller, and the like).

### First Example

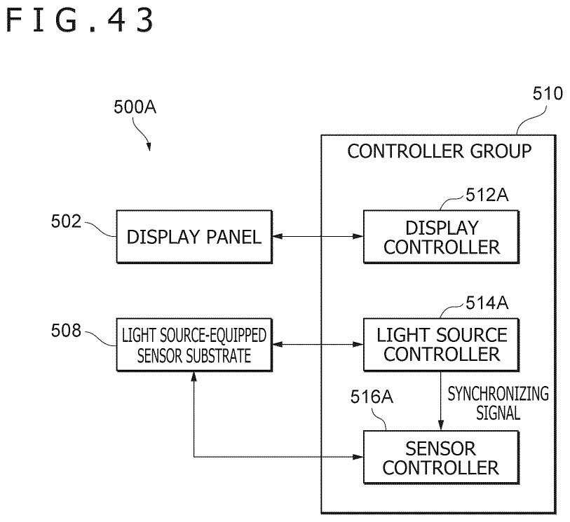

FIG. 43 is a block diagram illustrating a configuration of a display device 500A in a first example. This display device 500A includes a display panel 502, a light source-equipped sensor substrate 508, and a controller group 510.

The light source-equipped sensor substrate 508 is formed by integrally providing the light emitting element array 504 and the control target object 506. In this case, the control target object 506 corresponds to a coil group for detecting an electromagnetic induction type electronic pen (specifically, the sending coil or the detecting coils). The light source-equipped sensor substrate 508 may have any of the laminated structures in the foregoing first to fifth embodiments.

The controller group 510 in the example of FIG. 43 includes a display controller 512A, a light source controller 514A (corresponding to the first controller), and a sensor controller 516A (corresponding to the second controller). The display controller 512A is as described above with reference to FIG. 42, and therefore a description of operation thereof will be omitted.

The light source controller 514A performs light emission control on the light source-equipped sensor substrate 508. The sensor controller 516A performs electronic pen detection control on the light source-equipped sensor substrate 508. Here, the light source controller 514A and the sensor controller 516A perform the timing control such that a light emission period of the light emitting element array 504 and a scanning period of the electronic pen do not overlap each other. Here, the light source controller 514A is configured to generate a synchronizing signal, and supply the synchronizing signal to the sensor controller 516A.

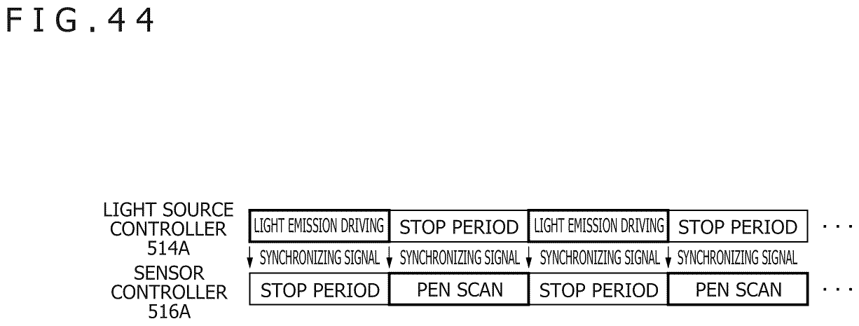

FIG. 44 is a timing chart of the timing control performed by the display device 500A illustrated in FIG. 43. First, the light source controller 514A supplies a first synchronizing signal to the sensor controller 516A, and starts the light emission control on the light source-equipped sensor substrate 508. The sensor controller 516A detects the first synchronizing signal and then stops pen scanning control on the light source-equipped sensor substrate 508.

Next, the light source controller 514A stops the light emission control on the light source-equipped sensor substrate 508, and supplies a second synchronizing signal to the sensor controller 516A. The sensor controller 516A detects the second synchronizing signal, and then starts the pen scanning control on the light source-equipped sensor substrate 508.

Next, the light source controller 514A supplies a third synchronizing signal to the sensor controller 516A, and starts the light emission control on the light source-equipped sensor substrate 508. The sensor controller 516A detects the third synchronizing signal, and then stops the pen scanning control on the light source-equipped sensor substrate 508.

Thereafter, the light emitting operation of the light emitting element array 504 and electronic pen scanning operation are performed on a time-division basis by repeating the above-described operations. Incidentally, the sensor controller 516A may perform an operation not affected by external noise or an operation not easily affected by the external noise (for example, a burst transmission) instead of completely stopping pen scanning during the above-described stop periods.

### Second Example

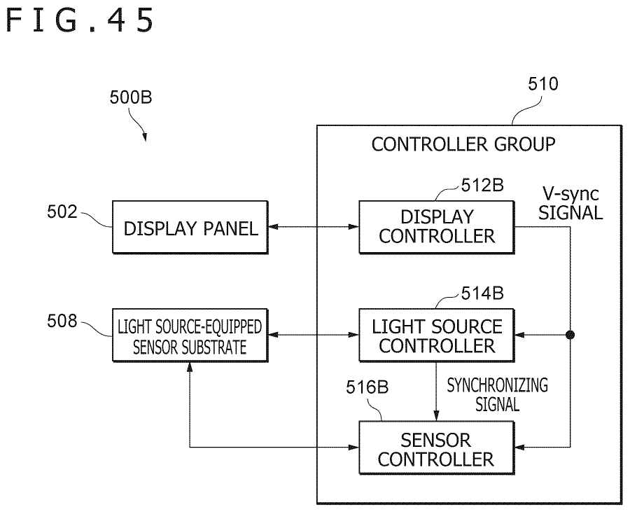

FIG. 45 is a block diagram illustrating a configuration of a display device 500B in a second example. This display device 500B includes a display panel 502, a light source-equipped sensor substrate 508, and a controller group 510.

As in the case of the first example (FIG. 43), the light source-equipped sensor substrate 508 is formed by integrally providing the light emitting element array 504 and the control target object 506. In this case, the control target object 506 corresponds to a coil group for detecting an electromagnetic induction type electronic pen (specifically the sending coil or the detecting coils). The light source-equipped sensor substrate 508 may have any of the laminated structures in the foregoing first to fifth embodiments.

The controller group 510 in the example of FIG. 45 includes a display controller 512B, a light source controller 514B (corresponding to the first controller), and a sensor controller 516B (corresponding to the second controller).

The display controller 512B performs display control on the display panel 502. Specifically, the display controller 512 receives image information or video information from a host processor not illustrated, and supplies a driving signal to an X/Y driver of the display panel 502 while performing the timing control by generating an H-sync signal and a V-sync signal. Then, each time the display controller 512B generates the V-sync signal, the display controller 512B supplies the V-sync signal to the light source controller 514B and the sensor controller 516B.

The light source controller 514B performs light emission control on the light source-equipped sensor substrate 508. The sensor controller 516B performs electronic pen detection control on the light source-equipped sensor substrate 508. Here, the light source controller 514B and the sensor controller 516B perform the timing control such that a light emission period of the light emitting element array 504 and a scanning period of the electronic pen do not overlap each other. Here, the light source controller 514B and the sensor controller 516B are configured to generate synchronizing signals by being triggered by the detection of the V-sync signal and mutually supply the synchronizing signals.

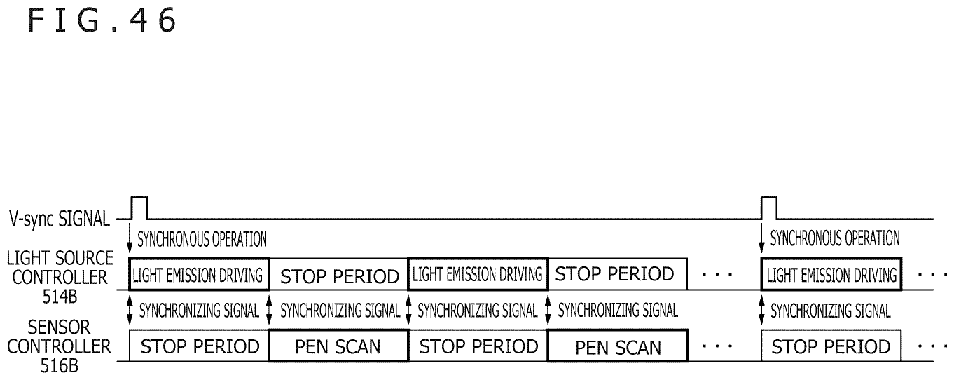

FIG. 46 is a timing chart of the timing control performed by the display device 500B illustrated in FIG. 45. First, the light source controller 514B generates a first synchronizing signal by being triggered by the detection of the V-sync signal and supplies the synchronizing signal to the sensor controller 516B, and starts the light emission control on the light source-equipped sensor substrate 508. The sensor controller 516B detects the first synchronizing signal, and then stops the pen scanning control on the light source-equipped sensor substrate 508.

Next, the sensor controller 516B generates a second synchronizing signal, and then starts the pen scanning control on the light source-equipped sensor substrate 508. The light source controller 514B detects the second synchronizing signal, and then stops the light emission control on the light source-equipped sensor substrate 508.

Next, the light source controller 514B generates a third synchronizing signal and supplies the synchronizing signal to the sensor controller 516B, and starts the light emission control on the light source-equipped sensor substrate 508. The sensor controller 516B detects the third synchronizing signal, and then stops the pen scanning control on the light source-equipped sensor substrate 508.

Thereafter, the light emitting operation of the light emitting element array 504 and electronic pen scanning operation are performed on a time-division basis by repeating the above-described operations. A shift in start timing of the light emitting operation or the pen scanning operation is adjusted through the detection of the V-sync signal. Incidentally, as in the case of the sensor controller 516A (FIG. 43 and FIG. 44), the sensor controller 516B may perform an operation such as burst transmission during the stop periods.

### Actions and Effects

As described above, the display device 500 in the sixth embodiment includes the non-emissive display panel 502, the first controller 514 that performs the light emission control on the light emitting element array 504, and the second controller 516 that performs the driving control on the control target object 506 different from the display panel 502 and the light emitting element array 504. The first controller 514 and the second controller 516 perform the timing control such that a light emission period of the light emitting element array 504 and a driving period of the control target object 506 do not overlap each other.

An effect of electromagnetic noise accompanying the light emitting operation of the light emitting element array 504 is reduced by thus performing the timing control such that a light emission period of the light emitting element array 504 and a driving period of the control target object 506 do not overlap each other. Particularly in a case where the first controller 514 performs the light emission control by the PWM dimming system, electromagnetic noise occurs easily as compared with the case of the analog dimming system, and therefore the effect of suppressing the electromagnetic noise appears more remarkably.

In addition, in a case where the display device 500B further includes the display controller 512B that performs display control on the display panel 502 by using a video synchronizing signal, the first controller (light source controller 514B in this case) and the second controller (sensor controller 516B in this case) may perform the timing control on the basis of the video synchronizing signal from the display controller 512B.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A light source-equipped sensor substrate comprising:
a plurality of mounting layers mounted with a plurality of light emitting elements arranged two-dimensionally along a first direction and a second direction intersecting the first direction as a light emitting element array, a driving wiring unit of the light emitting element array, and a coil wiring unit including a detecting coil group for detecting a signal from an electromagnetic induction type electronic pen; and
one or more insulating layers configured to insulate adjacent layers of the plurality of mounting layers from each other,
the plurality of mounting layers including:
a first mounting layer provided with at least the light emitting element array and a part of the driving wiring unit, and
a second mounting layer provided with at least a part or a whole of the coil wiring unit, and
the first mounting layer being further provided with a part of the coil wiring unit, and/or the second mounting layer being further provided with another part of the driving wiring unit.

2. The light source-equipped sensor substrate according to claim 1, wherein
the first mounting layer is provided on a first outermost layer side,
the second mounting layer is provided on a second outermost layer side, and
the first mounting layer is provided with at least a light source side terminal as a terminal of the driving wiring unit and a sensor side terminal as a terminal of the coil wiring unit.

3. The light source-equipped sensor substrate according to claim 2, wherein
the light source side terminal and the sensor side terminal are arranged side by side on a peripheral edge portion of the first mounting layer.

4. The light source-equipped sensor substrate according to claim 1, wherein
the first mounting layer is provided on the first outermost layer side,
the second mounting layer is provided on the second outermost layer side, and
the second mounting layer is provided with at least a light source side terminal as a terminal of the driving wiring unit and a sensor side terminal as a terminal of the coil wiring unit.

5. The light source-equipped sensor substrate according to claim 4, wherein
the light source side terminal and the sensor side terminal are arranged side by side on a peripheral edge portion of the second mounting layer.

6. The light source-equipped sensor substrate according to claim 4, wherein
the first mounting layer and the second mounting layer are connected to each other in a lamination direction via a through hole, and
at least one light emitting element is provided at a position of the through hole in the first mounting layer or on a periphery of the position of the through hole.

7. The light source-equipped sensor substrate according to claim 1, wherein
the plurality of mounting layers further includes a third mounting layer adjacent to the first mounting layer with the insulating layer interposed between the third mounting layer and the first mounting layer,
the third mounting layer is provided with a heat radiating solid member formed of a conductor, and
at least one slit is formed in the heat radiating solid member.

8. The light source-equipped sensor substrate according to claim 1, wherein
the driving wiring unit includes a plurality of pieces of linear wiring configured to extend in parallel with each other in one direction as viewed in plan from a lamination direction, and
the linear wiring includes:
connection wiring configured to extend to a connection destination with a branch point from cathode wiring of the light emitting elements as a start point, and
dummy wiring configured to extend in an opposite direction of going away from the connection destination with the branch point as a start point.

9. The light source-equipped sensor substrate according to claim 8, wherein
the closer to the connection destination the branch point is located, the longer the dummy wiring is, and the farther from the connection destination the branch point is located, the shorter the dummy wiring is.

10. The light source-equipped sensor substrate according to claim 1, wherein
the first mounting layer is provided on the first outermost layer side,
the second mounting layer is provided on the second outermost layer side, and
a mark indicating a position of a detection area formed by the detecting coil group is provided on the second mounting layer.

11. The light source-equipped sensor substrate according to claim 9, wherein
the mark or a base of the mark has a chromatic color.

12. The light source-equipped sensor substrate according to claim 1, wherein
the detecting coil group includes a plurality of detecting coils arranged so as to extend in one direction angled with respect to both the first direction and the second direction as viewed in plan from a lamination direction.

13. The light source-equipped sensor substrate according to claim 1, wherein
the detecting coil group includes a plurality of detecting coils arranged so as to extend in the first direction or the second direction as viewed in plan from a lamination direction, and
the driving wiring unit includes zigzag-shaped wiring configured to extend in a zigzag shape about one direction.

14. The light source-equipped sensor substrate according to claim 13, wherein
the one direction is a direction angled with respect to both the first direction and the second direction, and
the zigzag-shaped wiring is formed by a combination of a first line segment configured to extend in the first direction and a second line segment configured to extend in the second direction.

15. The light source-equipped sensor substrate according to claim 13, wherein
the one direction is the first direction or the second direction, and
the zigzag-shaped wiring is formed by a combination of a first line segment configured to extend in a first angled direction, angled with respect to both the first direction and the second direction, and a second line segment configured to extend in a second angled direction intersecting the first angled direction.

16. The light source-equipped sensor substrate according to claim 1, wherein
the detecting coil group includes a plurality of detecting coils disposed so as to extend in the first direction or the second direction as viewed in plan from a lamination direction, and
the driving wiring unit includes meander-shaped wiring configured to extend while meandering along the first direction and/or the second direction.

17. The light source-equipped sensor substrate according to claim 1, wherein
the driving wiring unit includes a plurality of pieces of linear wiring configured to extend in parallel with each other in one direction as viewed in plan from a lamination direction, and
one or more pieces of linear wiring among the plurality of pieces of linear wiring are configured such that a direction of current flowing through the one or more pieces of linear wiring is opposite from a direction of current flowing through remaining pieces of linear wiring.

18. A light source-equipped sensor substrate comprising:
a plurality of mounting layers mounted with a plurality of light emitting elements arranged two-dimensionally along a first direction and a second direction intersecting the first direction as a light emitting element array, a driving wiring unit of the light emitting element array, and a coil wiring unit including a detecting coil group for detecting a signal from an electromagnetic induction type electronic pen; and
one or more insulating layers configured to insulate adjacent layers of the plurality of mounting layers from each other,
the plurality of mounting layers including:
a first mounting layer provided with the light emitting element array and a part of the driving wiring unit,
a second mounting layer provided with another part of the driving wiring unit and a part of the coil wiring unit, and
a third mounting layer provided with another part of the coil wiring unit.

19. A light source-equipped sensor substrate comprising:
a first printed board mounted with a plurality of light emitting elements arranged two-dimensionally as a light emitting element array; and
a second printed board mounted with a coil group for detecting an electromagnetic induction type electronic pen,
in the second printed board, a plurality of window portions being formed at positions corresponding to the light emitting elements, and
the first printed board and the second printed board being laminated to each other in a state in which the light emitting elements are exposed via the window portions.

20.-28. (canceled)
